(19) United States
(12) Patent Application Publication
(10) Pub. No.: US 2018/0288126 A1
(43) Pub. Date: Oct. 4, 2018

(54) MONITORING DEVICES AND METHODS FOR IP SURVEILLANCE NETWORKS

(71) Applicant: IndigoVision Limited, Edinburgh (GB)

(72) Inventors: Michael Howard William Smart, Edinburgh (GB); Alexander Houston Swanson, Perth (GB)

(21) Appl. No.: 15/474,656

(22) Filed: Mar. 30, 2017

(30) Foreign Application Priority Data
Mar. 28, 2017 (GB) 1704931.3

(51) Int. Cl. H04L 29/06; H04N 7/18

(52) U.S. Cl. CPC H04L 65/80; H04L 69/22; H04L 67/02; H04N 7/181; H04L 65/608

(57) ABSTRACT

A network monitoring device and methods for monitoring data streams in an IP surveillance network. A capture filter of the device captures data packets from a data stream between first and second end-points of an IP surveillance network. A packet parser of the device parses packets captured by the capture filter to obtain packet information. A stream model of the device creates and stores stream records corresponding to data streams and either matches the packet information to a stream record listed in the stream model, or, if no match is found, to initialises a new stream record for the captured packet. A monitor of the device applies one or more rules to the captured packets and executes one or more actions based on the application of the one or more rules. A knowledge base of the device stores: information about components of the IP surveillance network; information about data streams between the components of IP surveillance networks; state information regarding the IP surveillance network, network components and network site; a plurality of IP surveillance stream templates for use by the stream model to initialise the stream records; and rules and actions to be applied to captured packets by the monitor.

### RELATED APPLICATION

The present application claims the benefit of and priority to United Kingdom Patent Application No. 1704931.3, filed on Mar. 28, 2017, which is incorporated herein by reference in its entirety for all purposes.

### FIELD OF THE DISCLOSURE

The present invention relates to monitoring devices and methods for IP surveillance networks, and IP surveillance networks incorporating such devices and methods. An application-specific IP networked monitoring device is described for use in IP surveillance networks. The device is designed to monitor for a number of different anomalies on an IP surveillance IT network. These anomalies may be caused by intentional malpractice (an agent attempting to disrupt, disregard policy, manipulate, extort or illegally use resources of the system) or non-intentional issues (poor device or network configuration, unexpected changes in device or network behaviour, or general health issues related to the system).

The device provides a low-cost, easy to install/manage, IP networked physical device capable of reporting a variety of issues to a number of different clients using application-specific terminology and application-pertinent remedial advice for manual or automatic prevention. The device can report to an IP surveillance Video Management System (VMS) and/or Security Information and Event Management (SIEM) systems.

The device can appear in a number of different form factors representing different product requirements. The device can be standalone product or incorporated as part of a parent device as an IP core. The device or core can be implemented in a number of ways, including software, hardware or a combination of both.

The devices are extensible and other related application-specific features, such as data logging, anomaly evidence recording and automated prevention can be added.

The device is based on many existing technologies but is specifically targeted to the IP surveillance market and integrating into the IP surveillance system itself, meeting the specific demands, technology and problems related directly to the surveillance industry.

### ACRONYMS USED IN DESCRIPTION

ASIC Application Specific Integrated Circuit

CCTV Closed Circuit Television

CLI Command Line Interface

CPU Central Processing Unit

DB Database

DDoS Distributed Denial of Service

DoS Denial of Service

DHCP Dynamic Host Configuration Protocol

DNS Domain Name System

FPGA Field Programmable Gate Array

GUI Graphical User Interface

HTTP Hypertext Transfer Protocol

HTTPS HTTP Secure

IP Internet Protocol

MAC Media Access Control (Ethernet)

NIC Network Interface Card

NIDS Network Intrusion Detection System

NIPS Network Intrusion Prevention System

NTP Network Time Protocol

NVR Networked Video Recorder

ONVIF Open Network Video Interface Forum

PC Personal Computer

PHY Physical (Ethernet physical layer)

PoE Power over Ethernet

PTZ Pan-Tilt-Zoom

RTCP Real Time Control Protocol

RTP Real Time Protocol

SDN Software Designed Network

SMTP Simple Mail Transfer Protocol

SNMP Simple Network Management Protocol

SoC System On Chip

SSH Secure Socket Shell

TCP Transmission Control Protocol

UDP User Data Protocol

SIEM Security Information and Event Management

VMS Video Management System

### BACKGROUND

An IP surveillance system is a digital networked version of the traditional analog video Closed-Circuit Television (CCTV) system. A typical IP surveillance system consists of a multitude of some or all of the following components
IP Camera—A configurable IP networked device that compresses and transmits video and audio from sensors (CMOS/CCD imagers, microphones etc) in a digital format. The device may also receive audio from a client for broadcasting via a speaker, as well as Pan-Tilt-Zoom (PTZ) commands to physically move the camera. The device can be configured remotely via different IP networking methodologies, such as HTTP/HTTPS. The device will transmit and receive various housekeeping information. The device can generate alarms onto the network from physical input sources, such as door entry systems. The device can also drive physical actions based on network inputs, such as opening doors.
IP Encoder—Technology that converts video from analog cameras to compressed video. From a network perspective the device behaves generally the same as an IP camera.
Networked Video Recorder (NVR)—A configurable IP networked device that records data, such as video, from IP cameras and encoders. Data recorded on the device can be played back to a number of clients at any time.
Digital Video Recorder (DVR)—Similar to an NVR but may also include the facility to encode video from an external input.
Video Management System (VMS)—A client software application that controls the IP surveillance system and allows for presentation of live and recorded video/audio, alarm/alert/event management, as well as a multitude of other features. Typically run on high-performance PCs in surveillance control rooms and used by human operators.
Mobile Client—A client VMS software application, usually with reduced functionality, to be used by operators, such as guards, outside of the control room using mobile devices such as smartphones and tablets.
Intrusion Detection Systems—Not to be confused with network intrusion detection systems (NIDS), these are devices that detect physical intrusion into a surveillance site, such as motion detectors. These devices are integrated into the IP surveillance network.

These components are typically installed and configured by a specialist IP surveillance installer or integrator. Their primary role is installation of the components.

The IP surveillance IT network is an IP-based network, typically Ethernet, on which the networked components described above are hosted. The network compromises of standard networking components including, but not restricted to, routers, switches, cabling and networked servers providing services like DHCP, DNS, NTP etc. and firewalling.

The surveillance network is typically configured and maintained by IT network managers. Their primary role is the definition of the network infrastructure, configuration, management, maintenance and security.

There are a number of important differences between IP surveillance networks and their behaviour, in comparison to other generic Ethernet networks/installations.

1. IP surveillance networks tend to use dedicated networks. These can be physically segregated networks with physically separate networking devices and IP surveillance components. Logical separation of IP surveillance networks using VLANs is also common.

2. Professional IP surveillance networks or devices are rarely directly accessible from the public Internet. External access is usually only for maintenance by installers or manufacturers.

3. IP surveillance systems are typically an enforced spend—they are not revenue generators like other systems that sit on an IP network. This issue makes systems and networks very cost sensitive in all but the highest security applications.

4. IP surveillance devices are complicated systems requiring specialised installers, not usually from an IT networking background. This can lead to a disjoint between the installers and site maintainers. Installation costs are related to install time, and can be significant.

5. Number of clients (data sinks) is relatively low. The number of data sources is very high in relation to data sinks.

6. Many devices in an IP surveillance network are similar/identical—e.g. multiple instances of the same camera model, same firmware, same manufacturer, and same configuration—meaning behaviour is often similar across devices. In recent years umbrella standards like ONVIF have meant increased behaviour similarity across vendors and availability of expected behaviours with these devices, and between these devices [see: https://www.onvif.org/].

7. The required functionality of IP surveillance systems can generate unique patterns of behaviour; e.g. multiple devices starting high data rate streams to one client at exactly the same time.

8. A large amount of expected connectivity between devices is known a priori by the VMS; e.g. which devices are going to be communicating with one another, and which devices definitely should not be communicating.

9. Device behaviour is binary in nature. During installation network traffic to/from a device is more random and there is a wide spread of Ethernet protocols used. After system configuration traffic on these surveillance networks tends to be relatively constant and static, comprising of a multiple of compressed data streams flowing in a many-to-one fashion to clients. High bitrate streams can run at all times. Other types of network traffic do occur after system configuration (starting/stopping streams, RTCP reports, NTP updates etc.) but again behaviour is reasonably predictable and repetitive. Much of this other traffic is critical to the correct running of the surveillance system, such as ensuring time synchronization across the system, including timestamping of evidential video used in legal prosecutions of events captured by the surveillance system.

10. Device/system configuration rarely changes after installation—typically only for scheduled device maintenance, device replacement or expansion of the system (addition of new devices).

11. IP cameras are often in physically hard to access, but often public, locations.

12. IP surveillance systems are about protection of a physical site. The IP surveillance network is a physical part of the site being protected. Network intrusion of dedicated and closed networks, such as those used in surveillance, may require some form of physical intrusion e.g. insertion of infected USB keys or other media, use of unlocked PCs or equipment etc.

Anomaly detection (the detection of something different from normal behaviour) is fundamental in many aspects of IP surveillance. Physical anomaly detection, and the evidential recording of this act with video and audio, such as perimeter intrusion, gunshots and theft, is common place. Logical anomaly detection in the network, such as network intrusion or changes in video stream characteristics, is less common. The latter form of anomalies fall into two categories: intentional and non-intentional, some general examples of which are described below. More specific examples are shown in Appendix A: Anomalies at the end of the present description.

### INTENTIONAL

An intentional anomaly is defined as the result, or intended result, of an act of intentional malice, or malpractice, by an automated electronic agent (bot) or human agent, on an IP surveillance network. Examples of intentional anomalies are:
Agent wishing to disrupt standard operating model of IP surveillance; e.g. intentional flooding of networks and surveillance with data to prevent normal operation (DoS).
Agent wishing to disrupt third-party services using IP surveillance devices e.g. DDoS attack.
Agent wishing to corrupt, remove or destroy existing evidential data; e.g. illegal command line login to a device and deletion of evidential recordings.
Agent wishing to utilise resources (CPU time) on IP surveillance devices for financial gain;

e.g. accessing a device to use CPU for other purposes (e.g. bitcoin mining)
Agent wishing to lock out IP surveillance devices for ransom; e.g. ransomware.
Agent wishing to view data (video, audio etc.) not privileged to view.
Agent wishing to disregard defined policies or good practice; e.g. a user accessing the command line on a device using Telnet as ‘root’, use of known default passwords.
Agent wishing to collude in an illegal act by reducing IP surveillance effectiveness; e.g. a valid operator moves a camera to an unusual position, such that an area of scene is not viewable
Agent attempting to perform an illogical act; e.g. IP camera to IP camera communication.
Agent wishes to gain physical access to a site by penetrating the network; e.g. sending a door open command to an IP camera controlling a physical access point.

Network Intrusion Detection Systems (NIDS) and Network Intrusion Prevention Systems (NIPS) are well known in the general network security industry for the detection and active prevention of intentional malpractice in an IT network [See: https://en.wikipedia.org/wiki/Intrusion_detection_system]. These generic devices can be incorporated into standard networked devices, such as routers and switches, or exist as separate monitoring entities on a network. These systems work using a number of techniques, including machine learning, to detect anomalous behaviour on an IT network. The advantages and intent of these systems are clear. However, in the realm of IP surveillance systems these types of systems are rarely deployed, except at the enterprise level. The reasons for this are as follows:

1. High costs—costs vary but can go up into the £10,000s plus annual maintenance fees

2. Dedicated and trained staff are required—both to install and maintain as well as to interpret and react to alarms produced by these systems

3. Complexity—systems must be designed to deal with a multitude of scenarios, protocols, network infrastructures, network users, and potential attacks on the system. This implies an unconstrained number of network behaviours and activities that need to be monitored.

4. High false alarm rate—wide range of possibilities on generic networks with large numbers of varying devices, software, applications etc.

5. Not integrated with VMS applications—logical anomaly detection not tied into the physical anomaly detection of the site being protected, inability to start live and/or recording video on a detected internal (to site) network intrusion e.g. server or control rooms.

6. Significant processing requirements—generic processing can lead to high processing requirements

7. Use on dedicated networks—feeling that dedicated networks that are not part of the public Internet are less susceptible to attack

8. Lack of application-specific information, processing or interpretation. For example a generic NIDS system may not parse application-specific pan-tilt-zoom protocol commands from a particular vendor for moving a camera such as “move left” or “zoom in”. Without interpretation of these application-specific commands anomalous behaviour is much harder to correctly detect.

### NON-INTENTIONAL

A non-intentional anomaly is defined as the result of an unintended change in system behaviour caused by failures in the system, or the dynamic and complex nature of the IP surveillance system. This is sometimes referred to as Health Monitoring. Examples of non-intentional anomalies are:
Performance of secondary devices having unintentional negative impact on primary assets; e.g. a valid client connects to a shared stream over an unreliable connection causing packet loss inducing error recovery mechanisms that reduce video quality for a primary recording.
Time-of-day dependent quality anomalies; e.g. changes in lighting increases video noise at night causing video quality to drop to unacceptable levels for prolonged periods of time.
Application critical information failure; e.g. loss of NTP updates to a device causing time drift and problems with evidential timestamping.
Misconfiguration of a device; e.g. configuration error in firewall or IP filter.
Non-standard device behaviour; e.g. malformed RTP packetisation, large RTP jitter.
Long term behavioural problems; e.g. long term bitrate analysis, zero or very low gain audio detection.

Health monitoring software does exist for CCTV [see: http://www.video-insight.com/VI-healthmonitor-cloud.php, http://www.checkmysystems.com/index.php/products/]. These are remote software applications, rather than being part of distributed (embedded) devices in an IP surveillance network. There is no element of connecting physical and logical intrusion detection, or NIDS/NIPS integration.

### SUMMARY

The present disclosure relates to various instantiations, implementations, integrations and variations thereof of an application-specific IP-enabled monitoring device/IP-core capable of the detection of intentional and non-intentional anomalies on dedicated IP surveillance networks. Devices described herein will integrate with a VMS and/or integrate with a generic NIDS/NIPS SIEM management system.

Potential benefits arising from one or more embodiments of the devices and methods described herein include:
Increased trust to end user that system and site are protected
Increased trust to end user that system is behaving as designed
Increased trust to end user that system is behaving optimally
Expert knowledge integration makes for trivial install but with maximal effect
Surveillance application-level interpretation of data
Simplicity of design and install keeps installation costs down, for rapid deployment
VMS integration ties together physical and logical anomalies, and alarm management
VMS integration provides a priori knowledge and reduces device configuration times
SIEM integration for network managers with more detailed levels of information
False alarms are reduced through simplicity and application-specific knowledge
Application-specific simplifications lead to reduced processing requirements and costs
Ability to incorporate complementary features
Significantly decreased diagnostic times and costs for problem resolution
Improvement and enforcement in installer and end-user security policies and process
Vertical IP surveillance market specialisation (e.g. banks, airports, casinos)

In accordance with its various aspects and embodiments, the present solution provides and/or uses a network monitoring device for monitoring data streams in an IP surveillance network that comprises a plurality of end-points, the end-points comprising network components and including at least one surveillance device and a surveillance management system:
where site-specific information from an IP surveillance system (such as device IP address, device type etc.) can be uploaded to the device;
where uploaded site-specific information (i.e. information about the specific site where the device is installed) is combined with in-built generic application-specific information (information applicable to all IP surveillance sites in general) to automatically generate rules for integrated NIDS/anomaly detectors;
where the generated rules are dependent on the state of the site being monitored; e.g. site/surveillance devices are currently being installed/configured, site is locked-down (surveillance devices operational and their configuration shouldn't be modified), time-of-day or other schedules;
where the local IP-surveillance network is modelled based on in-built and/or uploaded information and IP surveillance stream templates (e.g. defining how a particular surveillance device should work, for example a ONVIF camera will use RTSP/RTP etc.) and the network model is then updated based on traffic;
where the device is integrated with a VMS (for uploading of specific site information and for sending alerts to) rather than just an SIEM;
where the device can be incorporated into mirrored/tap-based monitors, switches, cameras, bridges etc.

One aspect of the present solution relates to a network monitoring device for monitoring data streams in an IP surveillance network, the IP surveillance network comprising a plurality of end-points, the end-points comprising network components including at least one surveillance device and a surveillance management system. The device comprises: a capture filter configured for capturing data packets from a data stream between first and second end-points of an IP surveillance network; a stream manager comprising a packet parser and a stream model; the packet parser of the stream manager configured for parsing packets captured by the capture filter to obtain packet information of the captured packets. The stream model of the stream manager is configured to: create and store stream records, each stream record corresponding to a data stream between a pair of end-points of the IP surveillance network; and, for each captured packet, either: to match the packet information of the captured packet to one of a plurality of stream records listed in the stream model, or, if no match is found, to initialise a new stream record for the captured packet;

a monitor configured for: applying one or more rules associated with the stream record to the captured packets based on at least one of the packet information of the captured packet and the content of the captured packet; and executing one or more actions based on the application of the one or more rules. The device may further comprise a knowledge base configured for storing: information about components of the IP surveillance network; information about data streams between the components of IP surveillance networks; state information regarding the IP surveillance network, network components and network site; a plurality of IP surveillance stream templates for use by the stream model to initialise the stream records; and rules and actions to be applied to captured packets by the monitor.

The knowledge base may be configured to receive and store information about components of the IP surveillance network uploaded from the surveillance management system and to generate the rules and actions to be applied to captured packets by the monitor based on properties in-built to the knowledge base, and properties derived from the information uploaded from the surveillance management system.

The knowledge base may further comprise rule-action templates and be configured to generate rules and actions to be applied to captured packets by the monitor using the rule-action templates. One or more of the rules and actions may be dependent on a current state, at the time of applying the rule or executing the action, of one or more of the network, the network components and the network site at the time of applying the rule or executing the action.

The packet parser may be configured to extract packet properties including source and destination addresses and application-level information. The stream model may be configured to update stream records based on packet information from captured packets matched to the stream records. A stream record may comprise a parent stream record and at least one sub-stream record. The parent stream record may correspond to a video stream and the sub-stream records may relate to one or more of a Real Time Protocol (RTP) sub-stream of the video stream, a Real Time Control Protocol (RTCP) sub-stream of the video stream and a Real Time Streaming Protocol (RTSP) sub-stream of the video stream.

The one or more actions may include at least one of: generating one or more alerts; blocking the captured packet and modifying one or more of the stream records, and communicating the generated alerts to the surveillance management system.

The stream model may be configured to match the packet information of the captured packet to one of the plurality of stream records by checking the captured packet against its list of streams using end-point addresses that define each particular stream.

In some embodiments the device may be configured to be connected to one of: the second end-point via a port of a network appliance located between the first and second end-points, the port mirroring network traffic traversing the network appliance; and an Ethernet tap located between the first and second end-points, and may further comprise a first network interface for receiving packets of the mirrored network traffic or of network traffic captured by the Ethernet tap. A second network interface may be provided for communicating with the surveillance management system.

In other embodiments the device may be configured to be located between the first and second end-points such that network traffic between the first and second end-points traverses the device, and may further comprise a first network interface for receiving packets of network traffic being monitored by the device and for transmitting received packets to the capture filter, and an Ethernet bridge that includes the capture filter and that communicates with the first network interface. The device may further comprise a second network interface that communicates with the Ethernet bridge for communicating, directly or indirectly, with the surveillance management system.

In some embodiments the device is integrated into an IP surveillance network component comprising one of a surveillance device (such as a camera) and a network appliance (such as a network switch).

The stream records may comprise stream statistics, event ordinality and status of past and currently active stream connections between network end-point pairs, and the stream model may be configured to incorporate data packet information into the stream records based on feedback from the monitor.

The monitor may further comprise an anomaly monitor configured to combine information from the stream manager with the captured packet and to use information and rules from the knowledge base to identify anomalies in at least one of the captured packet and the stream of which it is part, including anomalies specific to IP surveillance networks. The anomaly monitor may comprise at least one anomaly detector and an alert filter and the device may further comprise one or more of an alert manager, a device log, a firewall and a dynamic prevention module The anomaly detector may be configured to: receive the captured packet from the capture filter and stream and packet information from the stream model, apply one or more rules to the captured packet and the stream and packet information, and output information to the alert filter based the application of the one or more rules. The alert filter may be configured to: evaluate the information received from the anomaly detector, and output alert information based on the evaluation of the information received from the anomaly detector to one or more of the stream manager, alert manager, device log, firewall and dynamic prevention module. The anomaly monitor may further comprise an evidence control module and the device may further comprise an evidence vault configured to store data associated with alerts received from the evidence control module. The evidence control module may be configured to receive captured packets tagged by the alert filter and alert information from the alert filter based on its evaluation of the information received from the anomaly detector.

The knowledge base may be adapted to store information including static information about the IP surveillance network, known devices, physical site information and IP surveillance information. The information stored by the knowledge base may include policies for IP surveillance networks and devices, a connection matrix defining connections between devices in the network, device types, device properties, vendor specific information, scheduled activities, generic stream structures and behaviour patterns, alarm sources, stream configurations, Open Network Video Interface Forum (ONVIF) profiles, and state information for the network and/or individual network devices.

The device may further comprise a first network interface for receiving packets of network traffic being monitored by the device and for transmitting received packets to the capture filter. A second network interface of the device may communicate with the surveillance management system, and the device may further include an Ethernet bridge that includes the capture filter and that communicates with the first and second network interfaces. A surveillance management system interface of the device may be included for communicating with the surveillance management system via the second network interface, and a security information and event management (SIEM) interface may be included for communicating with a SIEM system via the second network interface.

The device may further comprise: an alert manager configured to receive and process alert information from the monitor and to send alert information to at least one of the surveillance management system and a security information and event management (SIEM) system. An evidence vault of the device may be configured to receive and store data associated with one or more alerts, and to receive and store packets tagged by the monitor and alert information generated by the monitor.

In accordance with another aspect, the present solution provides an IP surveillance network comprising a plurality of end-points, the end-points comprising network components including at least one surveillance device and a surveillance management system, the network including one or more network monitoring devices as defined above, deployed to monitor at least one data stream between at least one pair of network end-points.

In accordance with another aspect, the present solution provides a method of monitoring data streams in an IP surveillance network, the IP surveillance network comprising a plurality of end-points, the end-points comprising network components including at least one surveillance device and a surveillance management system. The method may comprise: capturing, by a capture filter of a surveillance monitor unit, data packets from a data stream between first and second end-points of an IP surveillance network; for each captured packet: parsing, by a packet parser of a stream manager of the surveillance monitor unit, the captured packet to obtain packet information of the captured packet; either: matching, by a stream model of the stream manager, the packet information of the captured packet to one of a plurality of stream records listed in the stream model, each stream record corresponding to a data stream between a pair of end-points of the IP surveillance network, the stream records listed in the stream model based on one of a plurality of stream templates provided by a knowledge base of the surveillance monitor unit, the knowledge base comprising: information about components of the IP surveillance network; information about data streams between the components of IP surveillance networks; state information regarding the IP surveillance network, network components and network site; a plurality of IP surveillance stream templates for use by the stream model to initialise the stream records; and rules and actions to be applied to captured packets by a monitor module of the surveillance monitor unit, or,

if no match is found, initialising a new stream record for the captured packet based on one of the stream templates provided by the knowledge base; applying, by the monitor module, one or more rules, provided by the knowledge base and associated with the stream record, to the captured packet based on the packet information of the captured packet and/or the content of the captured packet; executing by the monitor module one or more actions provided by the knowledge base based on the application of the one or more rules.

The surveillance device may comprise a camera and the data stream may comprise a video data stream.

The one or more actions may include at least one of: generating one or more alerts; blocking the captured packet; modifying one or more of the stream records; and communicating the generated alerts to the surveillance management system.

Matching the packet information of the captured packet to one of the plurality of stream records may comprise checking, by the stream model, the captured packet against its list of streams using source and destination addresses that define each particular stream.

In some embodiments, the surveillance monitor unit may be a device connected to one of: the second end-point via a port of a network appliance located between the first and second end-points, the port mirroring network traffic traversing the network appliance; and an Ethernet tap located between the first and second end-points.

In other embodiments, the surveillance monitor unit may be a device located between the first and second end-points such that network traffic between the first and second end-points traverses the device.

The surveillance monitor unit may be integrated into a component of the IP surveillance network, such as a surveillance device of the IP surveillance network or a network appliance located between the IP surveillance device and the surveillance management system.

The stream model may comprise stream statistics, event ordinality and status of past and currently active stream connections between network end-point pairs.

The method may further comprise incorporating data packet information into the stream model based on feedback from the monitor module.

The monitor module may comprise an anomaly monitor that combines information from the stream manager with the captured packet and uses information and rules from the knowledge base to identify anomalies in at least one of the captured packet and the stream of which it is part

The method may further comprise: receiving, by at least one anomaly detector of the anomaly monitor, the captured packet from the capture filter and stream and packet information from the stream model, applying, by the by anomaly detector, one or more rules to the captured packet and the stream and packet information, outputting, by the by anomaly detector, information to an alert filter of the anomaly monitor based the application of the one or more rules, evaluating, by the alert filter, the information received from the anomaly detector, and outputting, by the alert filter, alert information based on the evaluation of the information received from the anomaly detector to one or more of the stream manager, an alert manager of the surveillance monitor unit, a device log of the surveillance monitor unit, a firewall of the surveillance monitor unit and a dynamic prevention module of the surveillance monitor unit.

The anomaly monitor may further comprise an evidence control module, the device may further comprise an evidence vault and the method may further comprise storing, by the evidence vault, data associated with alerts received from the evidence control module, and receiving, by the evidence control module, captured packets tagged by the alert filter and alert information from the alert filter based on its evaluation of the information received from the anomaly detector.

The knowledge base may store information including static information about the IP surveillance network, known devices, physical site information and IP surveillance information. The information stored by the knowledge base may include policies for IP surveillance networks and devices, a connection matrix defining connections between devices in the network, device types, device properties, vendor specific information, scheduled activities, generic stream structures and behaviour patterns, alarm sources, stream configurations, Open Network Video Interface Forum (ONVIF) profiles, and state information for the network and/or individual network devices. The knowledge base may further comprise information about components of the IP surveillance network uploaded from the surveillance management system. The knowledge base may generate rules and actions to be applied to captured packets by the monitor based on properties in-built to the knowledge base, and properties derived from the information uploaded from the surveillance management system. The knowledge base may further comprise rule-action templates and may generate rules and actions to be applied to captured packets by the monitor using the rule-action templates. One or more of the rules and actions may be dependent on a current state, at the time of applying the rule or executing the action, of one or more of the network, the network components and the network site at the time of applying the rule or executing the action.

The method may further comprise extracting, by the packet parser, packet properties including source and destination addresses and application-level information.

The method may further comprising updating, by the stream model, stream records based on packet information from captured packets matched to the stream records. A stream record may comprise a parent stream record and at least one sub-stream record. The parent stream record may correspond to a video stream and the sub-stream records may relate to one or more of a Real Time Protocol (RTP) sub-stream of the video stream, a Real Time Control Protocol (RTCP) sub-stream of the video stream and a Real Time Streaming Protocol (RTSP) sub-stream of the video stream.

The method may further comprise receiving and processing, by an alert manager of the device, alert information from the monitor and sending, by the alert manager, alert information to at least one of the surveillance management system and a security information and event management (SIEM) system.

The method may further comprise receiving and storing, by an evidence vault of the device, data associated with one or more alerts, and receiving and storing, by the evidence vault, packets tagged by the monitor and alert information generated by the monitor.

### BRIEF DESCRIPTION OF THE DRAWINGS

Embodiments of IP surveillance network monitoring methods and devices, and networks employing such methods and devices, will now be described, by way of example only, with reference to the accompanying drawings, in which:

FIG. 1 illustrates a first embodiment of an IP surveillance monitor providing passive monitoring of an IP surveillance network using mirroring;

FIG. 2 illustrates the first embodiment of the IP surveillance monitor providing passive monitoring of an IP surveillance network using an Ethernet tap;

FIG. 3 illustrates a second embodiment of an IP surveillance monitor providing inline monitoring of an IP surveillance network using an Ethernet Bridge;

FIG. 4 illustrates the second embodiment of the IP surveillance monitor providing inline monitoring of an IP surveillance network using an alternative location for the Ethernet bridge;

FIG. 5 illustrates a third embodiment of an IP surveillance monitor integrated as an IP core in a managed Ethernet switch of an IP surveillance network;

FIG. 6 illustrates the third embodiment of an IP surveillance monitor integrated as an IP core in an IP surveillance device (camera) of an IP surveillance network;

FIG. 7 illustrates a knowledge base model template of embodiments of the IP surveillance monitor;

FIG. 8 illustrates the template of FIG. 7 populated with knowledge base device information;

FIG. 9 illustrates a stream model based on the template of FIG. 8 updated by incoming data;

FIG. 10 illustrates lateral stream associations;

FIG. 11 illustrates a stream manager of embodiments of the IP surveillance monitor;

FIG. 12 illustrates an anomaly monitor of embodiments of the IP surveillance monitor;

FIG. 13 illustrates rule generation in a knowledge base of embodiments of the IP surveillance monitor;

FIG. 14 illustrates a further example of an IP surveillance network.

### DETAILED DESCRIPTION OF PREFERRED EMBODIMENTS

IP surveillance monitors for use in IP surveillance networks are described herein with reference to several embodiments.

In the present disclosure the term “data stream”, or simply “stream”, refers to any form of IP-based communication between two end-points in an IP surveillance network. Each end-point is defined by a unique address, such as an IP address, and may include IP addresses such as multicast IP addresses. Network traffic of a stream between two end-points may be continuous and/or intermittent over periods of time. IP surveillance monitoring devices as described herein may be deployed at any one or more of a number of network locations so as to monitor streams between any pair of end-points for which monitoring is desired. As such, the particular end-points and types of end-points referred to in the following embodiments will be understood to be examples only.

The embodiments include three different implementation categories: passive, inline and integrated.

Passive embodiments simply monitor the network and generate alerts and reports. They are passive in the sense that they should not disrupt the working of the IP surveillance system itself

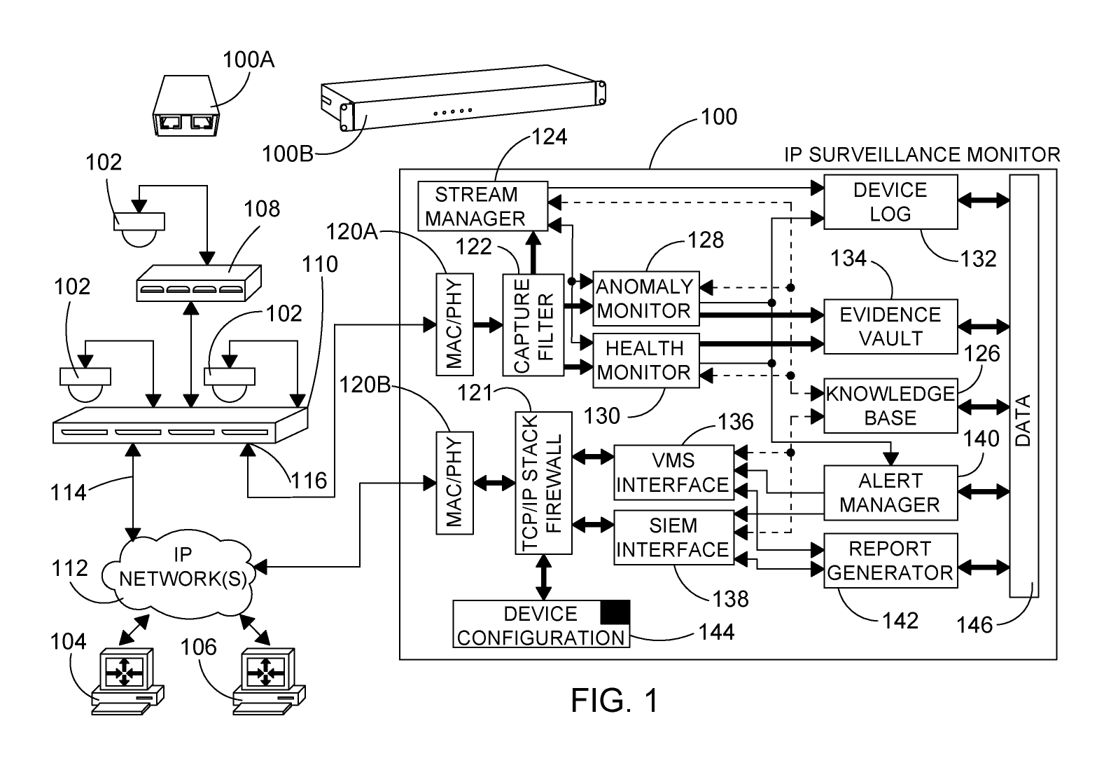

FIG. 1 illustrates a first passive implementation of an IP surveillance monitoring device 100 in a simplified example of an IP surveillance network that includes a plurality of IP surveillance devices 102, such as cameras, typically connected to an IP surveillance Video Management System (VMS) 104 and/or Security Information and Event Management (SIEM) systems 106, via one or more network appliances, such as an Ethernet switch 108 and a managed Ethernet switch 110, and one or more IP networks 112. In this example, network traffic from the surveillance devices 102 traverses the managed Ethernet switch 110 and is communicated to the IP network(s) 112 via an uplink 114.

The first passive implementation shown in FIG. 1 performs application-specific monitoring by attaching the monitoring device 100 to a mirrored Ethernet switch port 116 of the managed Ethernet switch 106. The port 116 can typically be configured to mirror the uplink 114 but can be configured to mirror ingress/egress of any port of the managed Ethernet switch 106. The uplink 114 carries traffic to other VMS and NVR IP surveillance components 104, 106. Bidirectional uplink traffic can be copied to the mirror port 116. This is a standard method for introducing a conventional NIDS device to a network [see: “Guide to Intrusion Detection and Prevention Systems (IDPS)”, National Institute of Standards and Technology, Special Publication 800-94].

The monitor 100, as shown in FIG. 1 can be deployed, for example, as software on a standard PC, or running as software within a standalone embedded device 100A with an embedded processor, or within a rack-mounted embedded device 100B with an embedded processor. The monitor 100 may also be implemented, for example, with an FPGA or ASIC.

The monitoring device 100 is described in more detail below. Boxes in the diagram of the monitoring device 100 represent functional elements of the monitor. Thicker arrows denote high bandwidth data paths and flows. Thinner arrows represent lower data bandwidth paths or signals. Dots represent connected signal paths. Dotted lines are simply to aid clarity in the diagram.

The IP surveillance devices 102 shown in the accompanying drawings are illustrated as IP dome-type cameras. However, the term “IP surveillance device” as used herein refers to any physical end-point in an IP surveillance network that contributes to the miming of the IP surveillance system. This includes, but is not restricted to, cameras, VMS clients, NVRs, alarm panels, and networked surveillance devices.

The elements shaded in grey in FIG. 1 represent the “IP surveillance monitor core”. When deployed on a dual-homed (two Ethernet interfaces) standard PC the other non-core elements will typically be provided by PC hardware (such as dual NIC) and standard software (capture drivers).

The IP surveillance monitor 100 of FIG. 1 comprises the following elements, interconnected as shown in the diagram.

MAC/PHY 120A, 120B are physical and low-level Ethernet interfaces. These are standard components in IP networking devices for interfacing to a physical Ethernet network. Choice of Ethernet speed 10/100/1000 etc. is dependent on device requirements. MAC/PHY 120A has an associated capture filter 122. MAC/PHY 120B has an associated TCP/IP stack and firewall 121. One potential PC configuration (not shown) replaces the second MAC/PHY configuration interface and TCP/IP stack with a GUI or CLI for direct interaction with a human operator. This may be suitable for very small installations. However, in order to integrate with a VMS the monitor core would be required to run on the same PC as the VMS.

Capture filter 122 captures all Ethernet traffic from the incoming connection 120A. The capture filter 122 can be configured to filter for only certain types of data that is of interest to the monitor 100. This is user configurable. Capture filters are common and available [https://en.wikipedia.org/wiki/Pcap]. The capture process may truncate data to reduce system processing requirements when inspection of the truncated data is not supported by system.

Stream manager 124 inspects incoming data packets for the purpose of building an application-specific stream model, as described further below. The stream model includes stream statistics, event ordinality and status of past and currently active streams connections between each relevant network end-point pairing. Examples include live video-only streams from a camera to a VMS or a playback video and audio stream from an NVR to a VMS. Stream manager 124 may examine (and view connections) at a Surveillance Application Layer rather than just at the Transport Layer (TCP or UDP). This also includes other application-critical “connections” such as time distribution (NTP), serial communications for PTZ or binary I/O contact commands; e.g. for door entries. Basic flow information can be supplemented by the parsing of data in each data packet for application-specific knowledge to be accumulated by the stream manager 124; e.g. times of day when doors are opened, where cameras are moved and by whom. The model for each end-point pairing is initialised using an application-specific model template, as well as properties, from a knowledge base 126 (described below). The model is further refined, and stream properties updated, based on incoming data packets. The stream manager 124 communicates the stream and parsed data packet information to an anomaly monitor 128 and/or health monitor 130 (described below). Data packet information may be incorporated into models based on feedback from the monitor(s) 128, 130. The stream manager 124 may also log pertinent information to a device log 132 (described below) but may also retain historical information regarding previous connections and actions.

Anomaly monitor 128 combines stateful information from the stream manager 124 with individual incoming packets, as well as using static information and rules from the knowledge base 126 to determine whether a current packet, or the current stream of which it is part (if any), is behaving abnormally. Abnormal behaviour will generate one or more alerts. Each alert may be coupled with a priority rating, unique identifier and any associated data. All packets may be passed to an evidence vault 134 (described below) regardless of the current alert status.

Device log 132 is a repository for any time-stamped pertinent device information. All elements can typically write to the device log 132, though the most important of these are indicated by the connections in the diagram. Examples of logged information typically includes (but is not restricted to) detected streams (source, client, media type), anomaly detection (anomaly type, priority), detected health issues (health type). The file structure and implementation of the device log 132 need not be defined herein. The log 132 may use volatile or non-volatile storage dependent on available resources/requirements.

Evidence vault 134 stores all data associated with one or more alerts as an incident, including all captured packets (before and after an alert) and any associated stream information. The specific format, implementation (including volatile or non-volatile storage) and structure of incident data in the vault 134 need not be defined herein. The vault 134 typically includes a pre-buffering mechanism to collect packets leading up to a potential alert. The duration of the pre-buffer, as well as post-alert duration, can be configurable.

Knowledge base 126 contains known static information about the specific IP surveillance network in which the surveillance monitor 100 is deployed, known devices, physical site information, as well as general IP surveillance information. This can include, but is not restricted to, inbuilt policies for IP surveillance networks and devices (which may include existing, published policies and guidance), network connection matrix, device types, device properties, vendor specific information, scheduled activities, generic stream structures and behaviour patterns, alarm sources, stream configurations, ONVIF profiles (known data such as a VMS site database uploaded via the VMS Interface) as well as the state of network, network site, or individual devices (e.g. in lock-down, installation, maintenance, replacement modes). The knowledge base 126 creates and populates application-specific model templates (described below) for the stream manager 124 for each stream. The knowledge base 126 generates application-specific rules, and associated actions, based on the static information for the monitors 128, 130. Rule-action pairs can be updated dynamically based on state (such as time of day, known schedules, user-defined exceptions, and updates). Knowledge base information is inbuilt and/or uploaded via VMS and/or SIEM Interfaces 136, 138.

Alert manager 140 processes alert information when triggered by one of the two types of monitor 128, 130. On triggering an alert, payload is created using data from the alert, device log 132 and possibly the evidence vault 134. Alert payloads can be created for use by either a VMS or SIEM or both. Payload information may include different information for different clients. The alert manager 140 typically sends alert payloads to the SIEM/VMS Interfaces for transmission when the alert priority level exceeds a configurable alert threshold for each individual interface. The alert manager 140 may filter out alerts (repeated identical alerts in a short time window) or combine alerts into a single message. The alert manager 140 can keep historical information of alerts processed and may alert itself based on rules provided by the knowledge base 126; e.g. based on a number of connected low-level alerts.

Report generator 142 generates reports when triggered by clients (VMS or SIEM) requesting status information from the monitoring device 100. Reports generated are typically specific to the client and are typically configurable in the amount of data produced. Reports can be, but are not restricted to, general device status reports, queries about specific alerts, time/date logs of streams, full alert or log downloads. Extraction of specific incidents from the evidence vault 134 may be done via the report generator using the unique alert ID allocated by the monitor 128, 130. The report generator 142 can also be used as an auditing tool reporting on detected changes and activity on the network.

SIEM interface 138 is an application level networking interface for SIEM clients. This may include support for SNMP, SMTP or direct communication to SIEM clients. The role of the SIEM interface 138 is to provide bi-directional communication between an SIEM client and the IP surveillance monitor 100. This can include alert and report generation, as well as keep-alive messages and configuration actions. Configuration information will typically be stored in device configuration 144 (described below).

VMS interface 136 is an application level networking interface for VMS clients. This may include support for ONVIF or direct communication to VMS clients. The role of the VMS interface 136 is to provide bi-directional communication between a VMS client and the IP surveillance monitor 100. Communication may use client-based authentication and/or encryption to provide secure communication between VMS and the IP surveillance monitor 100. Types of communication can include alert and report generation, as well as keep-alive messages and configuration actions. Uploading of site database information from a VMS can be done via the VMS interface 136. Configuration information will be stored in device configuration 144. It should be understood that the VMS interface 136 does not need to connect directly to the VMS and could communicate, for example, via a proxy server (a service acting on behalf of the VMS) or any intermediate application software/hardware.

Device configuration 144 provides configuration information for alternative configuration methodologies (such as CLI or HTTP/HTTPS) to the VMS/SIEM interfaces 136, 138 and for storage of device configuration parameters in non-volatile storage. Device configuration 144 will typically also comprise standard IP device functionality, such as DHCP, NTP clients, firewall/IP filter configuration etc.

Data 146 is a conceptual communication bus for bidirectional, random access, of back-end elements.

It should be noted that although single instances of elements of the monitoring device 100 are shown in FIG. 1, multiple instances of elements (or sub-elements) may be instantiated, for example to spread loading across multiple CPU processor cores to improve device throughput/performance. Typical elements suitable for this parallelization include the Stream Manager 124, Anomaly Monitor 128 and Health Monitor 130.

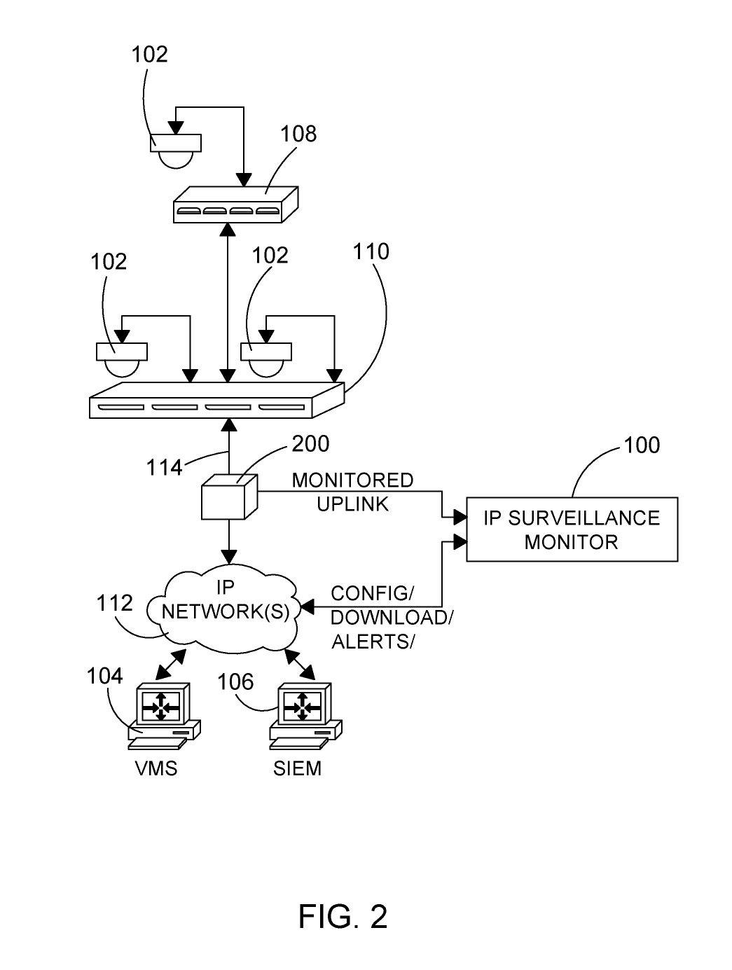

The use of port mirroring as illustrated in FIG. 1 has a specific advantage in that the physical network does not need to be modified, which facilitates integration into existing legacy sites. However, mirroring is not entirely passive in operation, for example when switches become loaded with traffic. In such scenarios switches can start dropping packets destined for the mirrored port. Because of these and other issues associated with port mirroring, an alternative is to use an Ethernet tap, tap panel, or filtered Ethernet tap, connected inline (in this example, with the uplink 114) [see: “Guide to Intrusion Detection and Prevention Systems (IDPS)”, National Institute of Standards and Technology, Special Publication 800-94; https://www.amazon.com/midBit-Technologies-LLC-10-100/dp/B00DY77HHK]. Use of the IP surveillance monitor 100 with an Ethernet tap 200 is shown in FIG. 2.

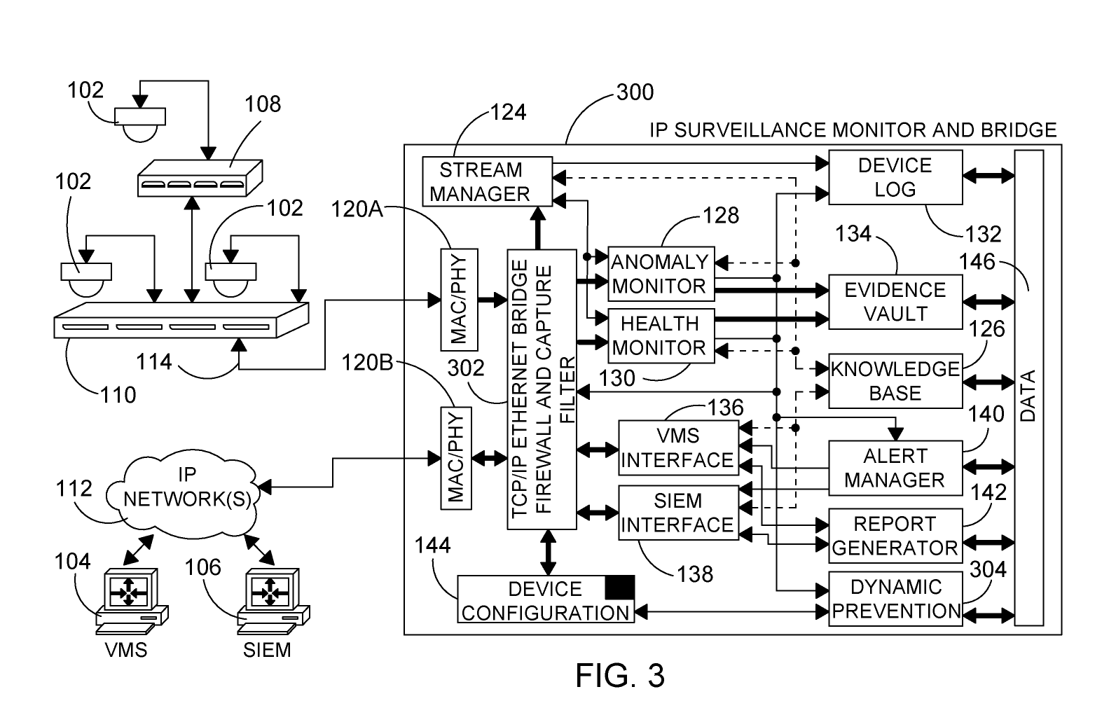

FIG. 3 illustrates an alternative embodiment of an IP surveillance monitor 300 in the context of an Ethernet bridge, configured for inline connection in the uplink 114 of the IP surveillance network. In this example the network components are the same as in FIG. 1 and are indicated by the same reference numerals. Most of the elements of the monitor device 300 are the same as in the monitor device 100 of FIG. 1 and are also indicated by the same reference numerals. FIG. 3 shows additional elements and connections between the elements of the monitor device 300, as discussed below.

In FIG. 3, the monitoring device 300 is placed inline between the switch 110 and the rest of the IP network. Inline connection of network devices is a standard approach and it is common to include conventional NIDS/NIPS functionality in high-end switches and routers themselves.

Inline connection of the monitor device 300 is potentially disadvantageous to the extent that it places performance requirements on the device in order not to impact on the performance of the IP surveillance network (i.e. it is non-passive). The device is also potentially more accessible and visible on the IP surveillance network to intentional malpractice. Further, device failure (e.g. loss of device power or software failure) could impact all monitored devices unless an electrical pass-through mechanism is implemented; i.e. it presents a new point of potential failure in the network. The device 300 should also be on-the-fly upgradeable, or not require upgrading, in order to avoid downtime of devices during an upgrade process.

However, there is a significant advantage to an inline monitor in that it can also act as a NIPS device (i.e. for intrusion prevention), not just as an NIDS device (i.e. for intrusion detection only); it can actively react and prevent malevolent packets reaching their destination. Again this is standard practice with conventional NIPS [see: “Guide to Intrusion Detection and Prevention Systems (IDPS)”, National Institute of Standards and Technology, Special Publication 800-94] and common practices are to block specific packets and/or protocols, terminate specific streams (connections) or change device configuration. FIG. 3 shows the IP surveillance monitor 300 instantiated in this inline operating mode.

There are two element changes in comparison with the monitoring device 100 shown in FIG. 1, as follow. The monitoring device 300 of FIG. 3 includes a TCP/IP Ethernet bridge 302, which incorporates the firewall and capture filter (elements 121 and 122 of FIG. 1), and further includes dynamic prevention 304.

The Ethernet bridge 302 is a standard IP networking component. Ethernet data is simply transferred from one MAC/PHY 120A, 120B to the other, according to standard bridging Ethernet bridging and firewall rules. The bridge 302 encapsulates the other standard TCP/IP components including capture filtering. Specific packets can be dropped immediately based on an alert, via dynamic prevention 304.

Dynamic prevention 304 makes decisions based on alerts and other available information and has the ability to make changes to the device configuration, based on the alerts. This can include modifications to the firewall, an IP filter or quarantining specific devices.

A further variation on FIG. 3 is to add a third MAC/PHY (not shown) to handle the uplink and leaving one MAC/PHY to act as a dedicated monitor port as shown in FIG. 1. This allows for improved security options by allowing the Ethernet bridge ports to act as a transparent bridge. Also the third monitor port can be made IP addressable but onto a separate IT management network. However, this would be at the extra expense of additional device cost and design complexity.

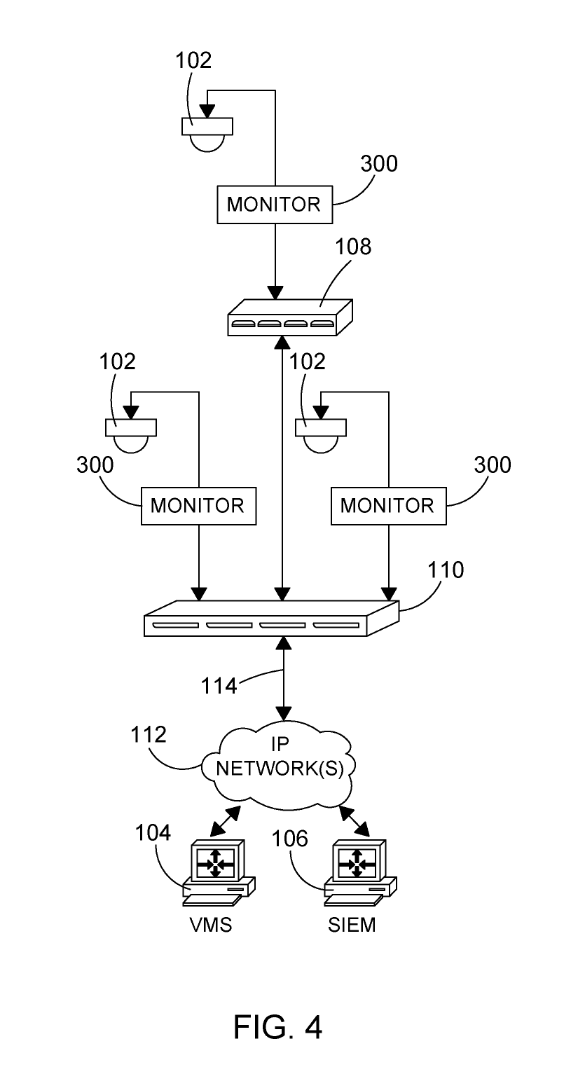

Positioning the monitor bridge variant 300 on the other side of the switch 108 or 110 is also a possibility, such that a monitor 300 sits directly between each IP surveillance device 102 to be monitored and the first Ethernet switch/device encountered by network traffic from the surveillance device 102, as shown in FIG. 4. This arrangement allows checking of all potential device-to-device communication, rather than just, for example, the uplink 114.

Many Ethernet switches deliver power over the Ethernet cable from the switch port (PoE/PoE+) in order to power the IP surveillance device. The monitor 300 may utilise this itself, or it may use an external power source, but it must also pass enough power onto the camera 102, using a PoE pass through mechanism.

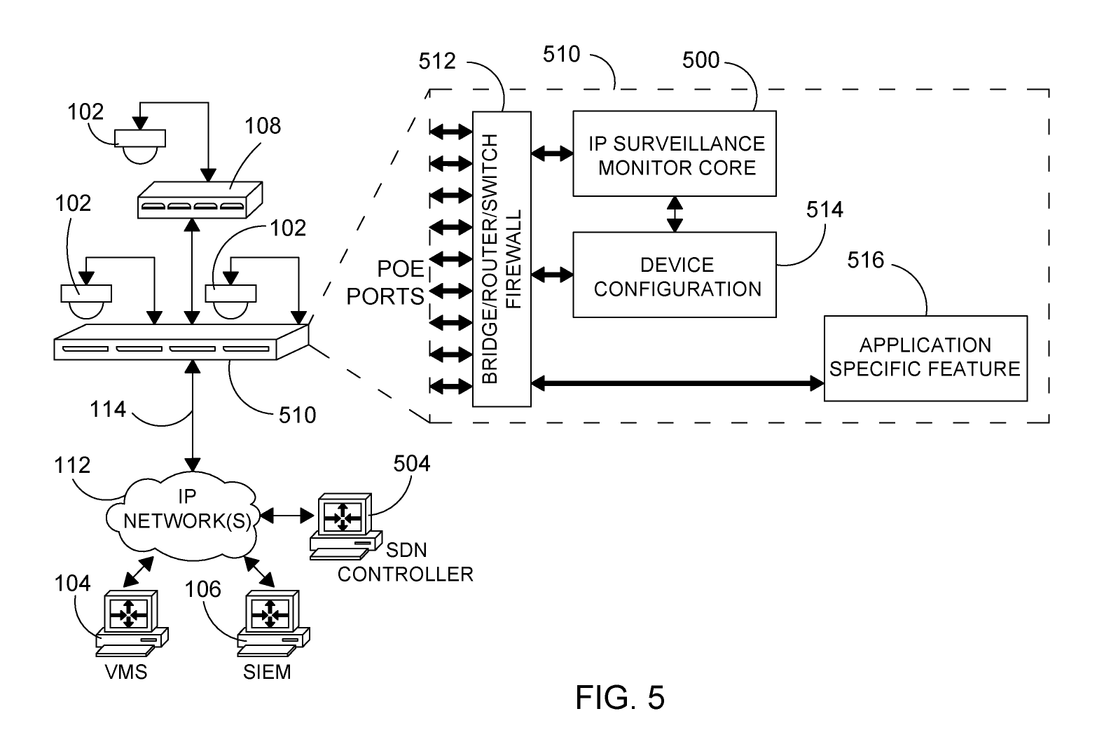

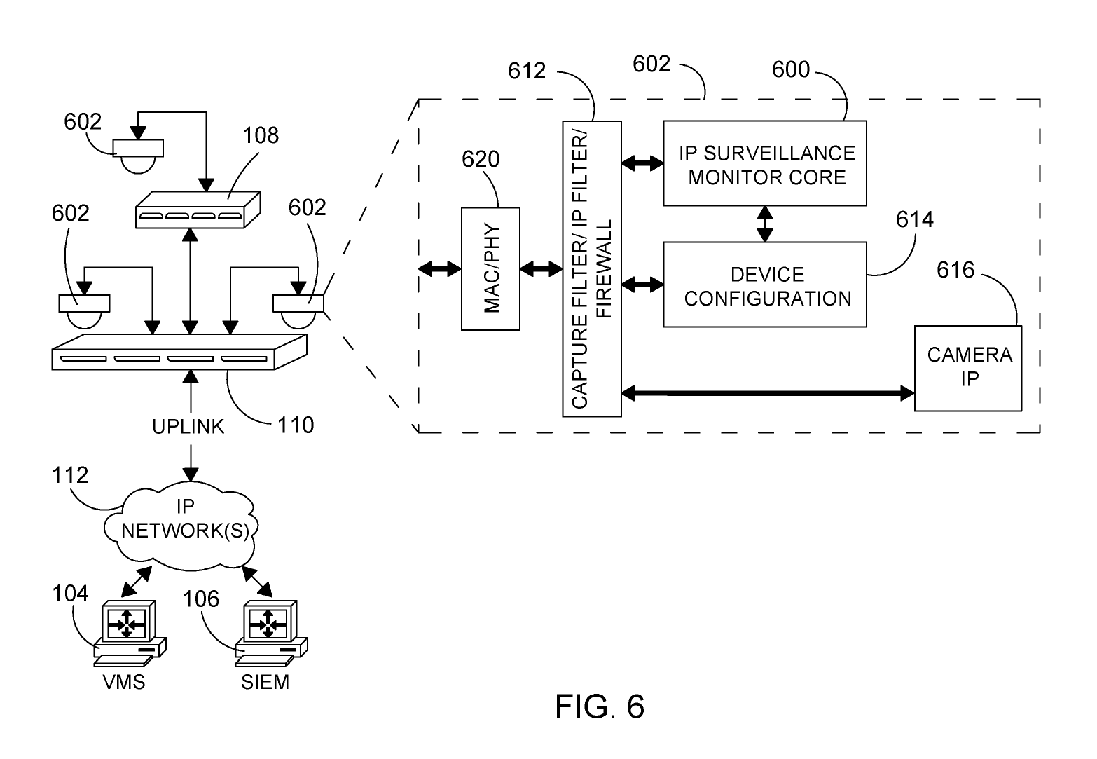

FIGS. 1 to 4 show examples of IP surveillance monitors implemented as standalone devices 100 and 300. The functionality implemented by these devices may alternatively be integrated as an IP core into another product/device rather than as a product/device in itself. Two options illustrated in FIGS. 5 and 6 are integrating an IP surveillance monitor core 500 into a managed Ethernet switch, router or other network appliance 510 (FIG. 5), or integrating an IP surveillance monitor core 600 into IP surveillance devices 602, such as IP cameras (FIG. 6).

The IP core 500, 600 include those elements of monitor 300 shown in grey FIG. 3; i.e. stream manager 124, knowledge base 126, anomaly monitor 128, health monitor 130, device log 132, evidence vault 134, VMS interface 136, SIEM interface 138, alert manager 140, report generator 142 and device configuration 144.

For switches etc. 510, as shown in FIG. 5, the IP core 500 can be implemented as a direct integration into a switch design for an application-specific networking appliance targeting the IP surveillance market. SDN networks may deploy the core 500 onto a white-boxed switch/router/gateway networking device from a centralised SDN controller service 504 [see: https://www.opennetworking.org/sdn-resources/sdn-definition]. In this latter case the IP surveillance monitor core 500 would be delivered onto these remote networking devices 510 as an integrated part of a virtualised SDN compatible software environment providing application-specific monitoring and protection to a particular segment of the network. The switch 510 will include its own conventional elements such as bridge/router/switch/firewall 512 and device configuration 514, and may further include additional application specific features 516.

For devices 602, such as IP cameras, the monitors 128, 130 and stream manager 124 in the IP surveillance monitor core 600 will be fed from the internally generated data streams at a suitable point close to the device's network interface 620. As tied to a specific device, like the inline device in FIG. 4, this version of the IP surveillance monitor core 600 may require only a subset of model templates, features, stream types, monitor types, rules and statistics and thus will require a smaller resource footprint. FIG. 6 shows the IP surveillance monitor core 600 instantiated in an IP Camera 602. As this is a network end-point, only a single MAC/PHY 620 is typical. This means that alert information/configuration will take place on the IP surveillance network. The device 602 will include its own conventional elements such as capture filter/IP filter/firewall 612 and device configuration 514 and camera IP 616.

Other examples of integrated locations for the IP Surveillance Monitor Core include in ASIC SoC chipsets, NVRs, DVRs, Ethernet PoE injectors or VMS hosted PCs.

The following describes some of the elements of embodiments of the IP surveillance monitors 100, 300, 500 and 600 in more detail.

For the purposes of the present disclosure, properties are any quantifiable attributes of network devices and data streams monitored by the monitor device. Properties can be defined, parsed or inferred from data, historical data, raw packet payload data, or generated e.g. statistical. Properties may be persistent, such as stream or knowledge base properties, or ephemeral, such as packet or interim monitor properties. The specific format for the expression of properties and rule-actions (discussed below) may be determined by the choice anomaly detector, which may be from an integrated lightweight NIDS/NIPS. For the purpose of this disclosure and to help explain the concept, device properties will be described using a hierarchical text-dotted format, similar to that used with SNMP. For example, the property that refers to the IP address of a stream source may be represented as stream.source.address.ip. For a particular stream that property might hold the value 192.168.0.5. A property may hold multiple values as an array e.g. kb. endpoints.cameras[ ] for the set of all valid camera endpoints. Property type elements may be, but are not restricted to, integer values, floating (fixed) point values, or strings. Templates are special (complex) properties but could be stored in string and/or integer format.

### Stream Models

As noted above, for the purposes of the present disclosure network data streams (generally referred to herein simply as “streams”) are defined as any form of IP-based communication between two end-points in an IP surveillance network. Each end-point is defined by a unique address, such as an IP address, and may include IP addresses such as multicast IP addresses. Streams may comprise one or more sub-streams, as described below.

Stream models provide a mechanism to describe what is believed to be the expected behaviour of a stream between two end-points in an IP surveillance network. The expected behaviour can include, for example, the expected order of packets in an ONVIF live video stream (RTSP start commands between a VMS and camera, followed by RTP media packets of a specific media type) or the existence of an NTP time stream for an IP camera. Expected behaviour can also capture what should not happen between two IP surveillance end-points; for example streams between two cameras.

Stream models provide a mechanism to encapsulate statistics about a stream accumulated by the processing of incoming data packets. These statistics provide application-specific data for anomaly and health detectors to detect changes in behaviour away from the model. A stream model comprises stream records for each unique stream or sub-stream.

A stream record is created from a stream template. A stream template is defined as a model generated from a priori knowledge, such as from a knowledge base 126, rather than dynamically from incoming data packets.

There are a number of possible ways to implement a stream model. One methodology is to use a connected graph. In this method a stream (or sub-stream) may be comprised of multiple sub-streams in a hierarchical fashion. Each sub-stream represents a potentially valid related component stream of the parent stream. For example, a video stream may be composed of RTP (compressed video data), RTCP (control data for the video stream) and RTSP (call control for the video stream), each of which themselves may be considered a stream. Each stream, or sub-stream, in the hierarchy has an associated set of fixed properties that can be populated from a priori knowledge or dynamically from parsed incoming data packets, and/or statistical properties, derived from the parsed incoming data packets. Statistical properties may include stream associations and state.

The number of properties of a stream is effectively unlimited and will be bounded by processing and memory availability in the surveillance monitor. The greater the number of statistics the more types of anomalies can be detected.

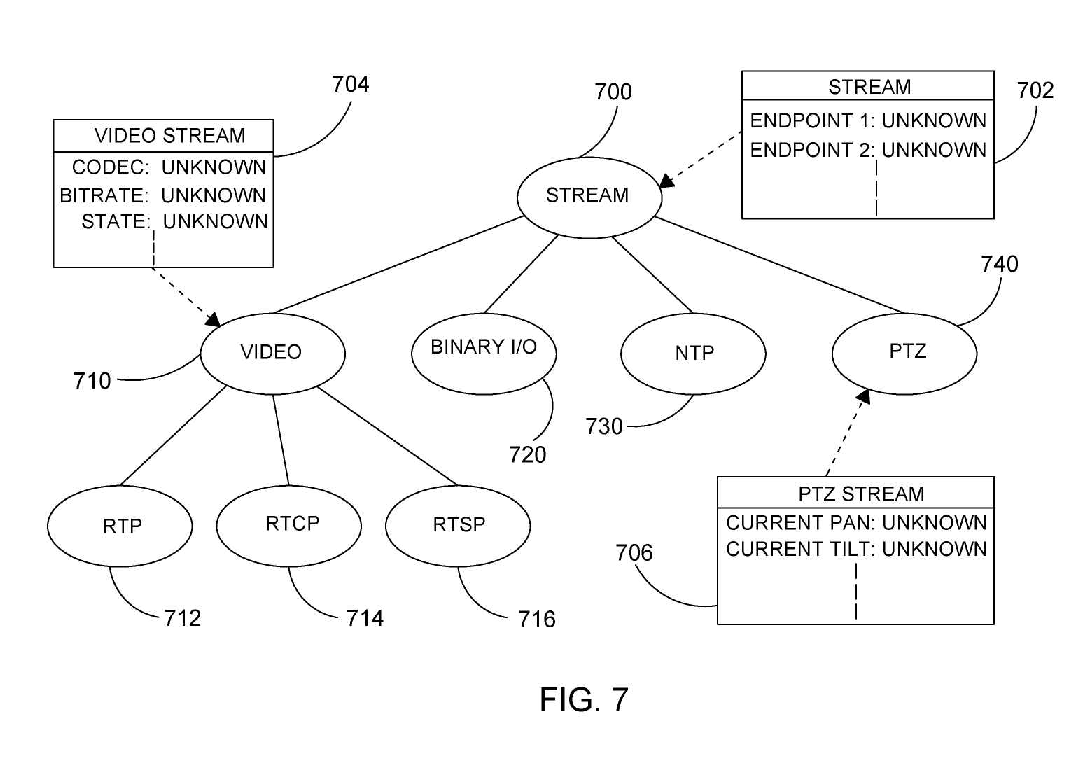

FIG. 7 shows a very simplified example of a knowledge base stream template using a connected graph. The template properties will be largely unknown but may include fixed relational properties. An example of a relational property is that a live video stream (camera to VMS) may have multiple potentially different types of valid video streams but must have at least one e.g. stream.video.minstreams=1. Another relationship property encoded in the template might be that RTSP packets must appear before RTP packets e.g. .stream.video.state.probabilityrtsptortp=100.

In the example shown in FIG. 7, a parent stream 700 template 702 includes fields for Endpoints 1 and 2. The parent stream 700 in this case includes possible substreams Video 710, Binary I/O 720, NTP 730 and PTZ 740. Video sub-stream 710 includes its own possible sub-streams RTP 712, RTCP 714 and RTSP 716. Video sub-stream template 704 includes fields for Codec, Bitrate and State. PTZ sub-stream template 706 includes fields for Current Pan and Current Tilt.

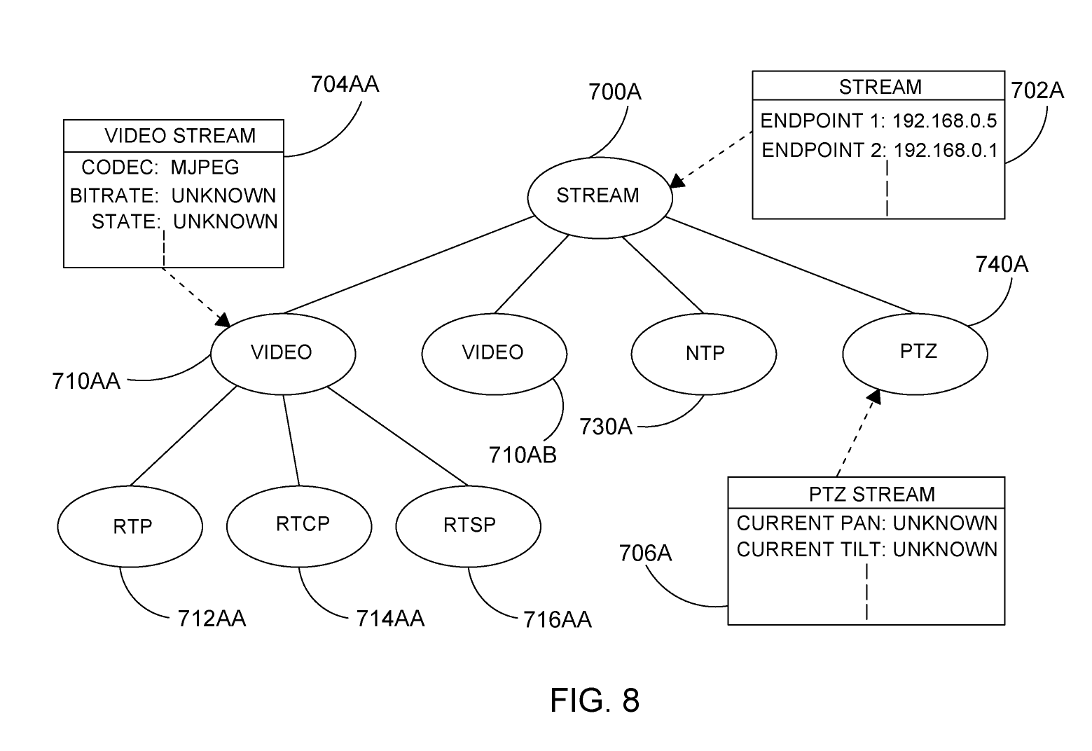

FIG. 8 shows a stream record for a stream 700A based on the template of FIG. 7 after a new connection has been detected by the stream manager 124 between IP addresses (end-points) 192.168.0.1 (in this example VMS 104) and 192.168.0.5 (in this example an IP camera such as 102), as indicated in stream record 702A based on stream template 702. The knowledge base 126 knows from the ONVIF profiles that two video streams are possible for this camera—the first an MJPEG and the second H.264—and thus creates two video sub-streams 710AA (codec=MJPEG as indicated in video sub-stream record 704AA based on video sub-stream template 704) and 710AB (codec=H.264, as would be indicated in a corresponding sub-stream template, omitted for clarity) in the model to handle them for when they occur. It should be noted that, although not shown in the diagram, that RTP, RTCP and RTSP sub-streams will also occur for the second video stream 710AB. The knowledge base 126 also knows the camera is a PTZ camera and that an NTP server is installed at 192.168.0.1. Policy also dictates the camera must receive NTP updates e.g. stream.needsntp=‘yes’. Finally the knowledge base 126 knows that no binary I/O detectors are configured so drops (prunes) the Binary I/O sub-stream 720 from the model.

End-point connections that do not match any a priori knowledge, e.g. IP addresses not matching any known network entities, will be tagged as an “Unknown” stream and will include all potential sub-streams. Such yet unidentified streams are good candidates for anomaly detectors (described below) of the anomaly monitor 128 and knowledge base rules. Sub-streams will be dropped (pruned) over time (i.e. over a learning period) if no evidence of a particular sub-stream is detected.

Associations between any streams or sub-streams in the model hierarchy can be modelled as a probability of association (0 to 100% representing no association to full association). Pruning of associations can be a binary activity—setting directly to 0% or 100%. Pruning can also happen over time by weakening the association (reducing the probability) when no pertinent data is detected or strengthening the association (increasing probability) when pertinent data is detected. This is similar to strengthening connections in a neural network. Pruning may be prevented by overriding properties; e.g. a stream must have one NTP source—in this case the association is never pruned (always 100%) and lack of NTP data will therefore be viewed highly suspiciously by the system.

The stream manager 124 now starts to populate the statistics in each of the streams by parsing incoming data packets at the various stream and sub-stream levels using protocol-specific knowledge. Data packets that fall out-with the model (i.e. packets having no relevant sub-stream association) will be flagged; e.g. packet.substream=‘binaryio’ and packet.inmodel=‘no’. Integration of the sub-stream association back into the stream model will be dependent on subsequent rule actions executed in the anomaly monitors 128, which are fed back to the stream manager 124.

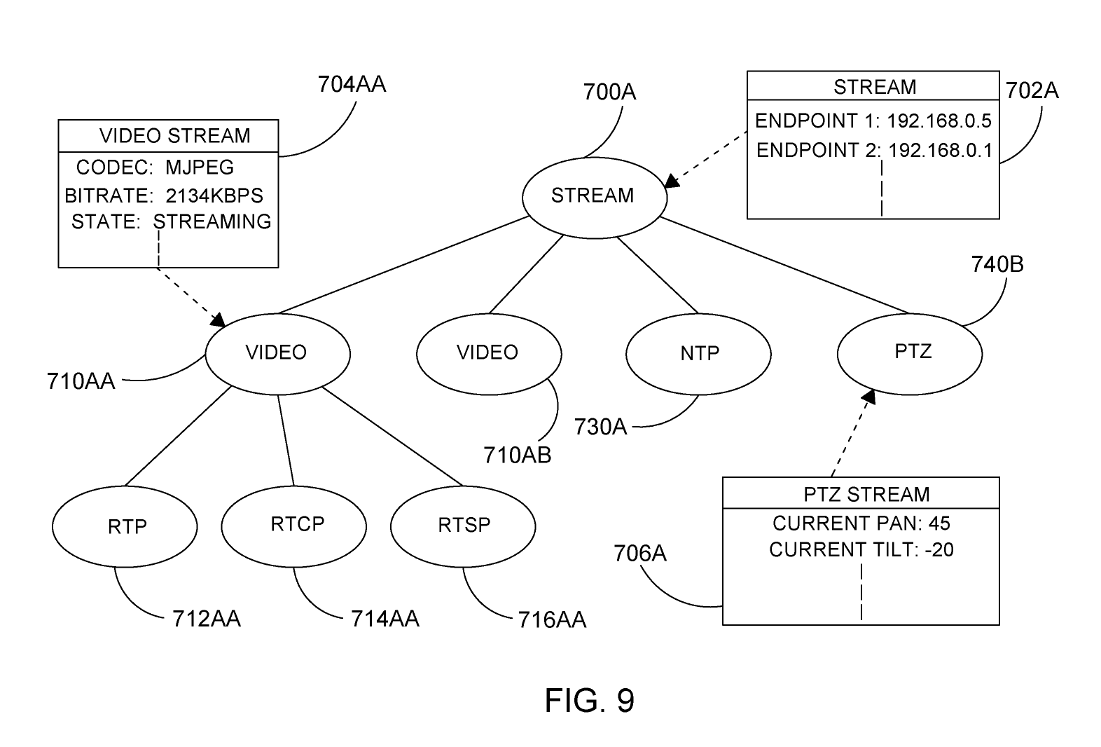

FIG. 9 shows the application-specific model in the stream manager 124 after processing input packet data for a period of time. No sub-stream components have been integrated back into the model to date and the existing streams have had their statistics updated on the basis of incoming parsed information; i.e. video sub-stream record 704AA shows Bitrate=2134 kbps and State=Streaming, PTZ sub-stream record 706A shows Current Pan=45 and Current Tilt=−20.

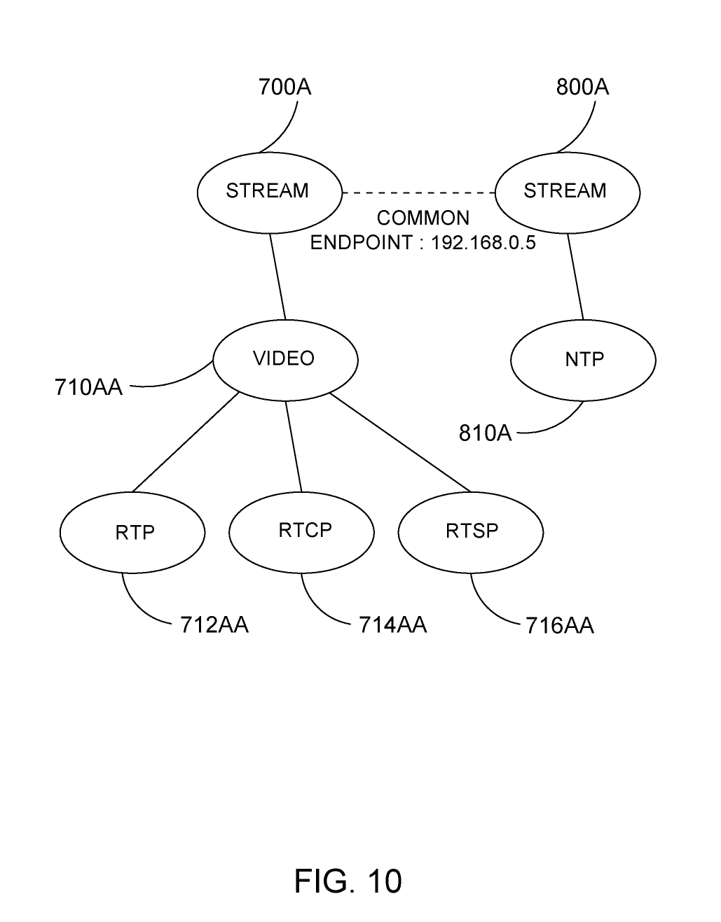

FIG. 10 shows a lateral association between the stream 700A of FIGS. 8 and 9 and a second stream 800A. Lateral associations are for streams (or sub-streams) that share a common end-point. In this example the live video stream 700A (camera 192.168.0.5 to VMS 192.168.0.1) has a lateral connection to an NTP stream 800A/810A (camera 192.168.0.5 and NTP server 192.168.0.2).

Lateral associations allow for common end-point associations such as use of dedicated NTP servers or for cameras with multiple clients e.g. streams to both an NVR and a VMS. Lateral connections allow for mandatory stream requirements to be met; e.g. if a stream must have a NTP source then the condition can be met via a lateral connection. Lateral connections also allow a rich, complex and complete model of the IP surveillance network to be developed.

These examples demonstrate how stream models can be used in the IP surveillance monitor. In practice there may be many more templates, types of streams and sub-streams in the knowledge base 126. Templates may go down as far as TCP acknowledgement sub-streams. Different templates might be designed for vendor specific surveillance devices, or other types of IP surveillance devices such as integrated alarm modules, alarm panels, NVRs or streaming gateways. Stream, and sub-stream types, can extend to a range of possibilities found in IP surveillance including audio, events (alarms), serial, HTTP(S), SSH etc.

The method described above shows one way to achieve stream models but there are other implementation options, such as finite state machines, lists, look-up tables, neural networks, and probabilistic state machines, such as Hidden Markov Models (HMMs) or Bayesian Belief Networks. Associations and stream/sub-stream relationships may also be more complex. Choice of implementation, template structures, complexity of models, variations in stream types, range of statistics, etc. can all be chosen to match available processing resources such as CPU, technology (hardware, software, hybrid) and available memory.

### Properties, Rules and Actions

The knowledge base 126 also provides a set of rules and actions to drive the monitors 128, 130 derived from application-specific information and knowledge of the application-specific stream models. This rule-action construct is simple and is common practice with conventional NIDS/NIPS systems. The rule-action works by providing the Monitors and Alert Manager with a set of simple conditional statements of the form
if (condition) action

The condition is typically dependent on stream properties, packet/protocol properties, alert properties, knowledge base properties, alert manager properties or monitor properties. Standard C-programming style conditional operators may apply, such as <, >, != but also extended operators can be defined such as “is a member of” or “contains pattern x” for signature-based byte-by-byte comparison. Data values representing items like threshold values (constants) are also possible in the condition definition.

An action tells the monitor 128, 130 what to do if the condition is met. Actions may include, for example: generate a specific alert or set of alerts, update a monitor property, block the stream, block the packet, do not integrate packet back into model, or combinations thereof. This is standard procedure for conventional NIDS/NIPS systems.

More complex rule-action conditional forms can be encoded. For example,
if (condition1) action1 else if (condition2) action2 else action 3

Rule-action pairs provided to the monitors 128, 130 may be changed or updated at any time by the knowledge base state or properties, such time-of-day.

The monitoring devices and methods described herein provide automated generation of the rule-actions based on application-specific information in the knowledge base as well as the ability to modify the rules dependent on state of the knowledge base properties.

### Stream Manager

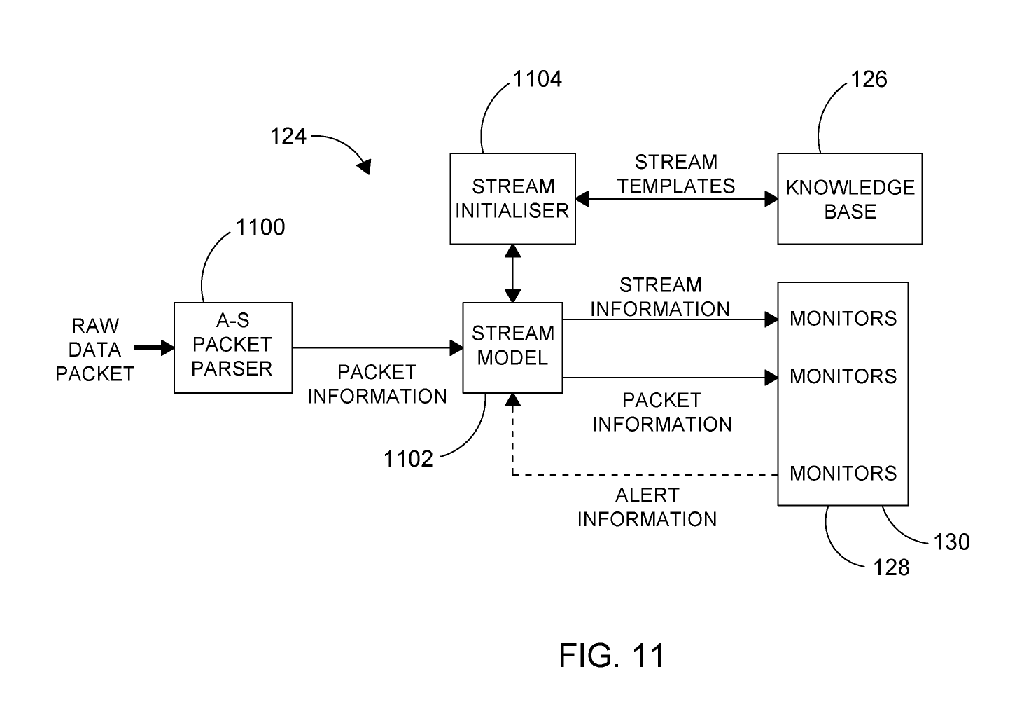

The stream manager 124 is responsible for packet parsing and validation, error detection, stream modelling, stream/packet property generation and model maintenance. The stream manager 124 uses explicit information and application-specific knowledge. FIG. 11 illustrates an example of an architecture for the stream manager 124, comprising an application specific packet parser 1100, stream model 1102 and stream initialiser 1102.

Raw data packets are first parsed into the application specific packet parser 1100. The parser 1100 dissects the packet and extracts properties such as source and destination IP addresses, MAC addresses, port numbers etc. The parsing of packets at this level is common functionality in software such as protocol analysers [see: https://www.wireshark.org/] But deeper parsing for application-level information is generally not found in these generic analysers. The monitors and methods described herein include parsing for application-level information such as alarm packets, binary I/O, PTZ or ONVIF commands be applied at this stage. Parse errors or inconsistencies may also be included in the packet information.

The stream model 1102 contains stream records for all current active streams and a number of previous streams that have occurred in the past, or have been dormant for a period of time.

The stream model 1102 checks incoming packets against stream and/or sub-stream records listed in the stream model using source and destination addresses; i.e. the end-points that define each particular stream. If no match is found a new stream record is initialised by the stream initialiser 1104 using a template from the knowledge base 126.

The stream model 1102 then validates the packet against the corresponding stream and/or sub-stream record and computes statistical properties about the packet in relation to the current state of the stream model 1102. These properties are tagged with the packet information. Examples of packet validation may include checking of correct ordering of packets in a stream (e.g. is packet expected given the state of the model), RTP sequence number as expected or unexpected for the applicable video codec type. Validation errors can be encapsulated as explicit packet properties or as a packet statistical property; e.g. packet.video.rtp.sequenceerror or packet.video.rtp.sequencedelta. Examples of statistical properties may include, for example, an estimate of the distance of a camera from its home position; e.g. packet.ptz.distancefromhome.

All stream and packet information is passed to the monitors 128 and/or 130 to be used as inputs to their detectors 1200 (described below).

Once the packet has been processed by the monitors 128, 130 it will be returned to the stream model 1102. Based on the type of stream and any alert/action information from the monitors 128, 130 the packet information may or may not be incorporated into the stream model 1102.

The stream manager 124 may receive notification of a knowledge base update via the stream initialiser 1104; e.g. an update to the network connectivity matrix. The stream manager will then be required to update the stream records with the new information.

### Anomaly Monitor

The anomaly monitor 128 is responsible for detecting more implicit (hidden) patterns, trends and anomalies in the incoming statistics and data, and is as such less explicit, and less application-specific, compared to the stream manager 124. The anomaly monitor 128 is also responsible for execution of rule-action lists provided by the knowledge base 126.

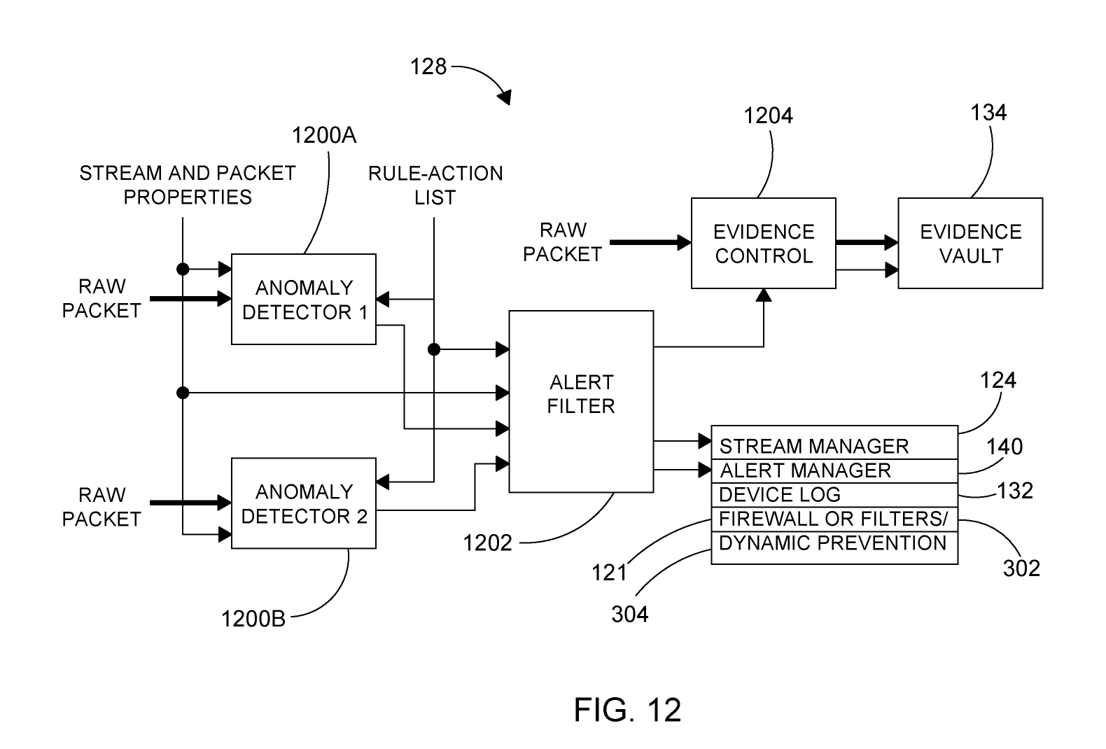

FIG. 12 shows an overview of the anomaly monitor 128, which comprises one or more anomaly detectors 1200A, 1200B, an alert filter 1202 and evidence control 1204. Inputs include the raw network packet data, from the capture filter 122, and the stream and packet properties, from the stream model 1102. The stream properties are all the stream properties associated with and relevant to that specific packet, as defined by the stream manager 124. The raw packet data is passed into the anomaly detectors 1200 and the evidence control unit 1204.

The anomaly monitor 128 will contain one or more anomaly detectors 1200A, 1200B working in parallel. There are many methods to detect anomalous behaviour, including rule-based, statistical inference or machine learning [see: https://en.wikipedia.org/wiki/Anomaly_detection]. Detection can be used on single input properties or payload data, or on multi-dimensional data. The monitors and methods described herein seek to improve how anomaly detection is used and implemented, rather than with anomaly detection in itself.

The operation of the detectors 1200 may be as simple as the evaluation and actioning of the rules provided by the knowledge base 126; e.g. a detector 1200 may just evaluate the rule “if (packet.protocol==45) alert(1, type 27), block” to check the parsed packet information for any Telnet communication.

The detectors 1200 may generate new statistical properties, based on the incoming data, which can be used by knowledge base rules; e.g. how a packet size deviates from the normal, in the rule “if (anomaly.monitor.packet.probabilitysizedeviation>80) warn(2, type 19)”.

Alternatively or additionally, a detector 1200 may comprise a highly complex anomaly detection engine, possibly based on that of an existing, conventional NIDS/NIPS system, with the rules from the knowledge base tailored for the NIDS/NIPS engine. That is, a monitor as described herein may take an existing NIDS/NIPS system and use the knowledge base to automatically generate rules for use by the existing NIDS/NIPS.

For the purposes of the following discussion, detectors 1200 will be treated as black boxes. Outputs from the detectors 1200 will be new properties, typically in the form of alerts or interim monitor properties. Typically, these properties will be probabilistic in nature. Application-specific information in-built into the rules provided by the knowledge base 126 will provide suitable thresholds for alert generation.

The alert filter 1202 performs and evaluates any outstanding rules, such as those from interim properties or alerts. The alert filter 1202 then forms the final list of alerts and actions for the current packet. These alerts are assigned unique identifiers and are output to other components of the IP surveillance monitor 100, 300, 500, 600 such as the alert manager 140 and device log 132 as well as driving components that control what happens to the packet or associated stream (blocked, firewalled etc).

The detectors 1200 may execute in parallel acting on the same rule but using different detection methods. The alert filter 1202 will then be required to decide between the different outputs. One method would be to use a simple voting scheme.

Individual detectors 1200 may be enabled or disabled dependent on knowledge base properties, including state. This may be implemented directly or via rules. For example, a heavy duty NIDS detector may be used during configuration of network devices (when there is low data bandwidth) and a very lightweight, streamlined, detector used during real-time locked-down operation (when there is high data bandwidth).

The alert filter 1202 will also inform the stream manager 124 of any decisions about the packet. This information can be used by the stream manager 124 to update stream records appropriately.

The alert filter 1202 drives the evidence vault 134 via the evidence control unit 1204. Packets may be tagged as needing to be stored in the evidence vault 134. Support information such as unique alert identifiers to allow for the future recall of evidence from the vault 134 may also be provided.

### Health Monitor

The health monitor 130 monitors for non-intentional anomalies. The structure of the health monitor 130 may be identical to that of the anomaly monitor 128 with the anomaly detectors 1200 replaced with detectors more suited for identifying health issues, such as poor quality video streams or average bitrates exceeding a knowledge base set limit.

The health monitor 128 will tend to be monitoring for more long term effects and anomalies, will tend to be more application-specific, and typically generates lower priority alerts for report generation and feedback to installers or manufacturers, of any recurring issues. With anomaly evidence stored in the evidence vault 134, this has significant diagnostic advantages especially with hard to reproduce problems. Further, new diagnostic rules can be uploaded to hunt for a specific problem with a network device or devices. This can substantially reduce diagnostic costs and can ensure faster problem resolution, as well as providing for a maximally performing and healthy IP surveillance system.

The health monitor detectors can be integrated into the anomaly monitor 128, and the separation of the anomaly and health monitors as described herein is largely conceptual to reinforce their different roles.

### Knowledge Base

The knowledge base 126, in one aspect, is an automated, application-specific rule generator for the anomaly and health monitors 128, 130, as well as the alert manager 140. In another aspect, the knowledge base 126 provides application-specific stream templates for the stream manager 124.

In a conventional NIDS/NIPS system, rule generation is typically performed manually by a skilled IT administrator. However, the administrator will have no or little application-specific information or knowledge about IP surveillance devices, and no information about application-specific payloads. The knowledge base 126 generates rules automatically using a range of in-built, uploaded and inferred application-specific information. Examples of the type of information that may be stored in the Knowledge Base include the following.

Connectivity matrices—Lists of known devices and details of which devices should be communicating with each other (e.g. camera to NVR) or should not be communicating with each other (e.g. camera to camera). This may include information like NTP server hierarchies. This information will predominately come from the site database uploaded from the VMS.

Default data—Device default data such as default usernames and passwords for different vendors. Typically this might be information that installers should have changed during configuration

Device identification—Type of device (camera, NVR, alarm panel, VMS, DHCP server, NTP server etc.), vendor/manufacturer, IP/MAC address.

Device configuration/properties—Firmware or software versions, ONVIF profiles, backup NVR device, PTZ capable, PTZ protocol, binary detectors etc.

Device protocols/ports—Lists of acceptable and unacceptable IP protocols and port numbers for IP surveillance products including any vendor specific knowledge. Acceptability may be a function of state; e.g. Telnet, SSH, HTTP(S) may not be allowed if a system is in a lock-down state, but allowed in a configuration state.

Inferred—Information that has been inferred or calculated from other knowledge base information; e.g. number of devices from a specific vendor.

Physical site information—Information about the physical surveillance site, such as opening/working hours.

Scheduled network security events—Vulnerability scans of devices that may include device port-scanning.

Scheduled physical security events—For example: guard tours may trigger door opening events or motion sensors that will appear on the network; detector activation/deactivation schedules, e.g. when a monitor detector is enabled.

State—For example: system or individual device is currently being installed, upgraded, reconfigured or in lock-down (i.e. no device configuration allowed). Can also include whether new versions of firmware are available for surveillance devices, general threat/paranoia level from a user or the alert manager 140. State may be used to dynamically change or alter rules or alert thresholds.

Templates—Behavioural templates for normal, abnormal and rule generation for IP surveillance devices.

The amount or type information stored/uploaded into the knowledge base may be a function of the target platform processing capabilities (more knowledge potentially implies more rules, requiring greater processing requirements and storage), where the device is placed in the network (range or number of devices to monitor), or even target market (different knowledge may be uploaded based on the type of IP surveillance site or market vertical (bank, casino, airport etc.).

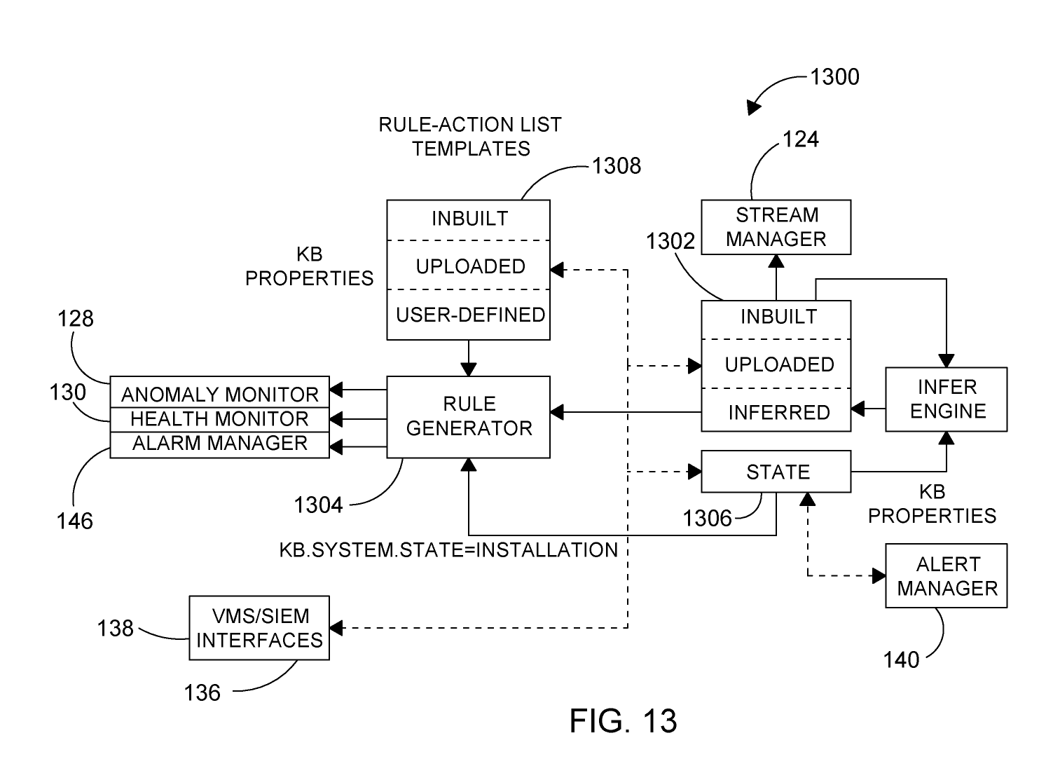

Knowledge base rule generation can be implemented in a number of ways. FIG. 13 illustrates a simple implementation by way of example. Knowledge base properties 1302 may be in-built (e.g. kb.vendor.macaddressprefix), uploaded from the VMS (e.g. kb.endpoints.cameras [ ]) or inferred from any of the other properties (e.g. kb.statistics.probabilityfixedcamera). Knowledge base properties 1302 are available to the rule generator 1304 in order to build rules. State 1306, as described above, comprises special types of knowledge base property, used to control when rules are generated.

Rule-action list templates 1308 are used by the rule generator 1304 to create the rules to drive the monitors 128, 130 and alert manager 140. Rules will be generated if the dependent properties exist (have been uploaded, inferred or in-built) in each rule template 1308. Stream and packet properties are defined as in-built. The rule generator 1304 will also only generate rules when dependent state conditions are met.

Examples of rule templates 1308 include:
1. Rule template that generates a rule for the anomaly monitor 128 if a Telnet connection is detected when the system is in lockdown; i.e. when no surveillance device configuration is allowed. The rule tells the anomaly monitor 128 to generate a high priority (1) alert of type 27 and also to block the packet, if possible, from retransmission (e.g. using dynamic prevention 304).
   if (kb.system.state==lockdown) generate_anomaly_rule(“if (packetprotocol==45) alert(1, type 27), block”)
2. Rule template that generates a rule for the anomaly monitor 128 if the knowledge base 126 contains a list of PTZ camera endpoints. In this case, create a rule for the anomaly monitor 128 that if the current stream is not a PTZ camera but the current packet is a PTZ packet then generate a low priority (3) alert of type 124.

```
if ( exist kb.endpoints.ptzcameras[ ] )
      generate_anomaly_rule( “if ( stream.camera.address.ip
      notamember
                  kb.endpoints.ptzcameras[ ] and packet.ptz )
                  alert( 3, type 124 )” )
```

3. Rule template always generated for the health monitor 130 that stipulates if the number of I-frame requests in the current video stream exceeds a threshold over a short period of time exceeds a threshold (indicating errors or missing data notifications from stream client, such as a VMS or NVR) then generate a warning.
   generate_health_rule(“if (stream.video.recentiframerequests>10) warn(2, type 52)”)

User-defined rule template exceptions, such as “if (alert.type==124 and stream.camera.address.ip==192.168.0.105) ignorealert”, to ignore alerts of type 124 generated for a specific camera, can be uploaded at any time into the knowledge base 126, in response to events and previous alerts. The exception list could be uploaded as a list into the knowledge base properties 1302, rather than being a constant in the rule template e.g. “if (alert.type==124 and stream.camera.address.ip ismember kb.alert124.exceptions.address.ip[ ]) ignorealert”.

The use of alert properties is an example of a rule hierarchy as the alert property was set as the consequence of another rule. It is possible for rule actions to set interim properties, for example in the monitor 128, 130 generate_health_rule(“if (stream.video.recentiframerequests>10) health.property12=100”)

where health.property12 can be used by other rules in a hierarchical fashion. This can simplify and reduce the number of rules and processing requirements, so is a practical consideration. Rule hierarchies are common in expert systems that embody expert application-specific knowledge.

Rules may be applicable to all detectors 1200 or specific detectors 1200 only. Associations between rules and detectors 1200 may be tagged with each rule-action pair.

Modifications to the rule templates (and properties) can be made at any time. The rule generator 1304 may modify (add, delete, update) the existing set of current actioning rules based on changes to the knowledge base properties 1302, including state 1306, as well as time-based schedules; e.g. rules changing at a specific time. The alert manager 140 may provide state information to the knowledge base 126 about current threat levels e.g. unusually large numbers of low priority alerts. This may trigger a change in thresholds or alert priorities by new or replacement rules.

Stream templates, as opposed to rule templates, are also inbuilt, or uploaded, similar to any other knowledge base property. Stream templates define application-specific hierarchical and temporal relationships between streams and sub-streams. The stream manager 124 may access the knowledge base 126 to extract a suitable stream template when a new stream is detected.

### Deployment

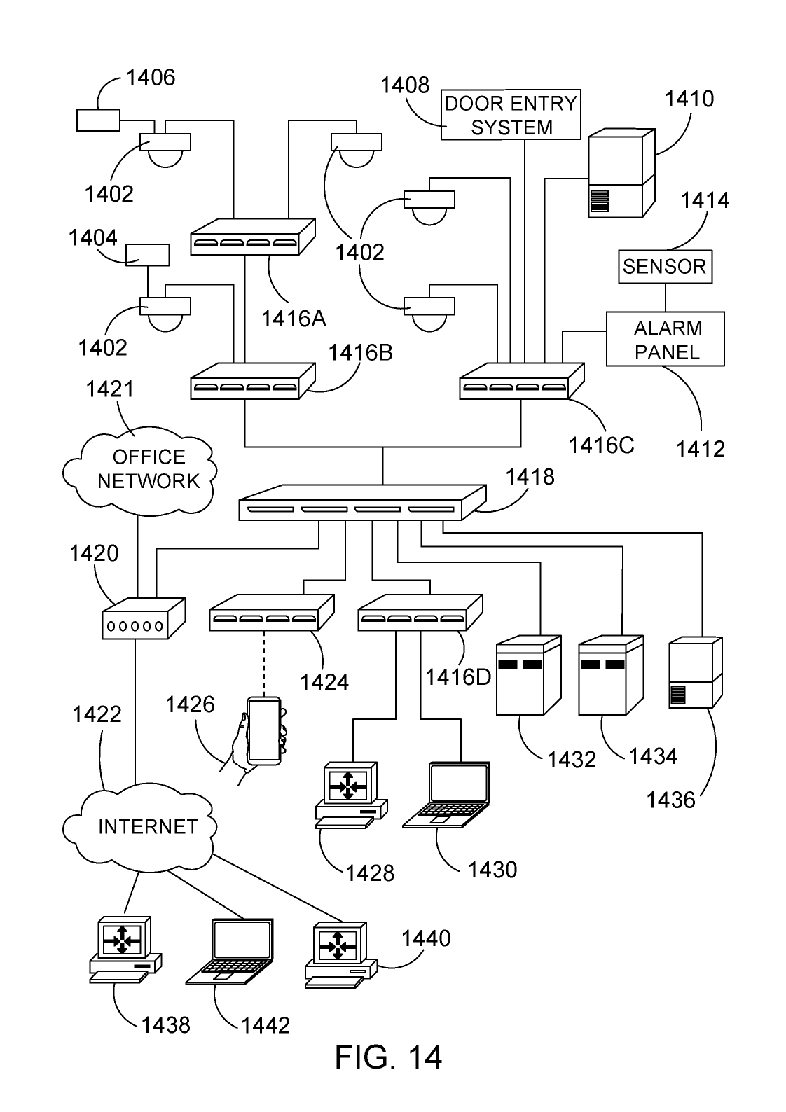

FIGS. 1 to 6 illustrate very simple examples of IP surveillance networks with passive, inline and integrated versions of the monitoring devices at particular network locations. FIG. 14 illustrates a more realistic (but still relatively simple) example of an IP surveillance network. The network of FIG. 14 includes IP cameras 1402, one of which has a PTZ unit 1404, a door intercom system 1406, a door entry system 1408, an NVR 1410, an alarm panel 1412 and associated sensors 1414, switches 1416A-D, a core switch 1418, a router/firewall 1420 providing connections to an office network 1421 and the Internet 1422, a WiFi hotspot 1424 providing network access to mobile clients 1426, VMS 1428, an installer workstation 1430, NTP Time Server 1432, DHCP/License Server 1434 and NVR/Alarm Server 1436. Legitimate remote users connecting to the network via the internet 1422 may include a remote VMS client 1438 and a camera manufacturer 1440 (e.g. for debugging cameras). A hacker 1442 may also seek to access the network via the internet 1422. The monitors described herein may be deployed to monitor data streams between any pairs of end-points in the network.

IP surveillance monitoring devices could be placed anywhere in the network. Each monitor is only capable of monitoring the streams that pass through the specific point in the network being monitored.

Examples of data streams that may be monitored include, but are not limited to, the following:
Alarm packets from the alarm panel 1412, generated by the sensor 1414 (e.g. a PIR—infra red motion detector), sent to and recorded on Alarm Server 1436. The Alarm Server can notify the VMS 1428 of the new recorded alarm.
Audio from a microphone connected to the VMS 1428 is compressed by the VMS and sent to the intercom system 1406 connected to one of the IP cameras 1402.
Standard live stream from a camera 1402 to VMS 1428. Video and audio are encoded in the camera, transmitted to the VMS client for decoding and presentation on screen. Sub-streams going from VMS 1428 to camera 1402 are also usual, for acknowledgements and time keeping.
An unauthorised stream from hacker 1442 to one of the cameras 1402, where hacker 1442 has managed to gain access to the IP surveillance network from the public Internet 1422 and has secondarily gained control of a camera on the network via Telnet or SSH protocol. The stream in this case may include commands for installation of an infection.
Video Playback from NVR 1410 to VMS 1428 of video from a camera 1402 that has been previously recorded onto an NVR, when a VMS operator has requested playback of the recorded video stream.
PTZ control from a mobile VMS client 1426 controlling the Pan-Tilt-Zoom mechanism 1404 on an IP camera 1402. This stream comprises a series of control packets (e.g. move left, zoom in etc. . . . ) for the PTZ unit.
Recording of video from a camera 1404 to NVR 1436. This recorded video can be reviewed at some later point by the VMS 1428.
Remote access by an authorised VMS client 1438, via the Internet 1422, accessing a video stream from one of the cameras 1402.
Network Time Stream from NTP time server 1432 to a camera 1402. Cameras are dependent on knowing accurately the time of day and all devices on the network need to be synchronised. A time server stream constitutes of periodic time packets from the time server 1432 to all components on the IP surveillance network.

Streams will run concurrently on the IP surveillance network. There are also other possible configurations of IP surveillance networks, and other devices and streams not described here. Most streams will have a dominant direction of data traffic but most will have some form of bi-directional communication.

### Implementation

The IP surveillance monitor 100, 300, 500, 600 is implementable in either hardware, such as an FPGA, in software on a general purpose, or embedded processor system, or in a hybrid of both.

If implemented for a general purpose or embedded processor then components, such as the stream manager 124, may simply be implemented in software. Components may use standard resources such as memory, storage and peripherals available through either an operating system API or bare metal code support code. Components may pass data through standard software interfaces or APIs.

If implemented in hardware, such as an FPGA, ASIC SoC or ASIC, components can be constructed using combinations of combinatorial logic, registers, and paged, multi-ported embedded memory (SRAM). Components may use signal wires and simple data buses to communicate. Components may be able to use standard resources available through hardware interfaces provided by the FPGA and glue logic.

Hybrid implementations may use soft-core processors in an FPGA fabric, FPGA SoC or ASIC with embedded processor, such as an ARM core.

Floating-point operations may be required to generate some statistics but, in the monitors described herein, use of an integer fixed point alternative will generally be acceptable.

The number of features, complexity of models, information stored, and statistics generated, algorithms used and performance may vary dependent on the target platform. This will be a cost-benefit decision in product design. For example, some designs/applications may not require the evidence vault 134, which has potentially high storage overheads. However, the underlying architecture of the IP surveillance monitor will remain the same.

While the present solution has been described with respect to a limited number of embodiments these embodiments are illustrative and in no way limit the scope of the described methods, devices or systems. Those skilled in the art, having benefit of this disclosure, will appreciate that other embodiments can be devised which do not depart from the scope of the invention as disclosed herein. Accordingly, the scope of the invention should be limited only by the attached claims.

### APPENDIX A: ANOMALIES

The following lists some detailed examples of specific potential anomalies. The list is divided into two sections. The first covers standard networking anomalies (that may be detectable by a standard NIDS/NIPS detector), the second covers more application specific IP surveillance anomalies. The list is an example, not a complete (exhaustive) list and is intended is to demonstrate different types of anomaly.

### Standard

| Name | Description |
|---|---|
| Atypical packet size | Packet size is different from normal |
| Involuntary stream | Data stream has started without usual client |
| | preamble |
| MAC address change | Source/destination MAC address has changed for |
| | specific IP address |
| Port scan detected | Device has been scanned by a network device |
| Unusual stream client | Data has started streaming to a non-typical client |
| Unusual port activity | Stream or communication on an atypical port or |
| | port range |
| Unsolicited data | Large amounts of unsolicited data targeted at |
| | camera or device |
| Use of Telnet | An insecure communication protocol has been |
| | used to communicate |

### Application Specific

| Name | Description |
|---|---|
| Audio only stream | IP cameras do not stream only audio from camera |
| Bitrate profile | Unusual/non-typical video or audio bitrate profile. Change in |
| | environment, camera failure or loading |
| Camera to camera | Cameras are communicating. This should never happen. Devices are |
| | identified as cameras from the site database. |
| Codec mismatch | Compressed data does not match ONVIF profile |
| Configuration attempt | A client is attempting to configure a device via ONVIF or HTTP(s) but |
| | the network is not installation mode, or device not in maintenance |
| | mode |
| Configuration switch | Configuration has switched to a different profile (configuration) |
| Default user/password | Default username and password detected (vendor specific) |
| Device not in site DB | Communication with a device not in VMS database (site database) |
| Erratic PTZ movement | Camera is moving erratically. Requires interpretation of PTZ |
| | commands. |
| Error recovery | Client is requesting I-frame requests from camera. Suggestions of |
| | networking issues causing effects on live streams. |
| Frame dropping | Video frames are being lost. Requires detection of typical frame rate. |
| High jitter | Video/audio with large or untypical jitter |
| High volume audio | Audio stream indicating sustained very high gain levels |
| I-frame attack | Very high I-frame (key frame) RTCP requests suggesting intentional |
| | attack on camera to cause disruption to stream |
| Invalid ONVIF data | Invalid ONVIF communication to/from ONVIF detected device |
| Invalid payload | Payload data not as expected e.g. no compression start codes detected |
| Invalid use of SSH | Communication with a device after installation. Requires information |
| | on state of network and device. |
| Loss of NTP | Loss of NTP updates to device |
| Low video quality | Video quality has gone very low for a sustained period |
| Non-ONVIF device | Detected device is not ONVIF |
| Old ONVIF protocol | Older version of ONVIF protocol detected |
| Out of hours access | Client requesting door opening out of normal building working hours |
| Recording errors | High priority version of “Error recovery”. Effected device is an NVR |
| | (site database). Potential loss or reduction in quality of evidential data. |
| RTP sequence number | RTP sequence numbers |
| Unusual door access | Door access requests at a non-typical time of day, or number of |
| | requests in a short amount of time |
| Unusual stream count | Unusual number of streams from a device |
| Unusual time change | NTP update indicates an unusably large NTP delta (time change) |
| Unusual PTZ client | An unusual but valid client is moving a camera |
| Unusual PTZ location | Camera has been moved to a location that is untypical. Requires |
| | interpretation of PTZ commands and PTZ movement history. |
| Unusual vendor | Camera/NVR MAC address indicates a different vendor or device to |
| | others |

1. A network monitoring device for monitoring data streams in an IP surveillance network, the IP surveillance network comprising a plurality of end-points, the end-points comprising network components including at least one surveillance device and a surveillance management system, the device comprising:
a capture filter configured for capturing data packets from a data stream between first and second end-points of an IP surveillance network;
a stream manager comprising a packet parser and a stream model;
the packet parser of the stream manager configured for parsing packets captured by the capture filter to obtain packet information of the captured packets;
the stream model of the stream manager configured to: create and store stream records, each stream record corresponding to a data stream between a pair of end-points of the IP surveillance network; and, for each captured packet, either:
to match the packet information of the captured packet to one of a plurality of stream records listed in the stream model, or,
if no match is found, to initialise a new stream record for the captured packet;
a monitor configured for: applying one or more rules associated with the stream record to the captured packets based on at least one of the packet information of the captured packet and the content of the captured packet; and executing one or more actions based on the application of the one or more rules; and
a knowledge base configured for storing: information about components of the IP surveillance network; information about data streams between the components of IP surveillance networks; state information regarding the IP surveillance network, network components and network site; a plurality of IP surveillance stream templates for use by the stream model to initialise the stream records; and rules and actions to be applied to captured packets by the monitor.

2. The device of claim 1, wherein the knowledge base is configured to receive and store information about components of the IP surveillance network uploaded from the surveillance management system and to generate the rules and actions to be applied to captured packets by the monitor based on properties in-built to the knowledge base, and properties derived from the information uploaded from the surveillance management system.

3. The device of claim 2, wherein the knowledge base comprises rule-action templates and is configured to generate rules and actions to be applied to captured packets by the monitor using the rule-action templates, wherein one or more of the rules and actions is dependent on a current state, at the time of applying the rule or executing the action, of one or more of the network, the network components and the network site.

4. The device of claim 1 wherein the packet parser is configured to extract packet properties including source and destination addresses and application-level information.

5. The device of claim 1, wherein the stream model is configured to update stream records based on packet information from captured packets matched to the stream records.

6. The device of claim 5, wherein a stream record comprises a parent stream record and at least one sub-stream record.

7. The device of claim 6, wherein the parent stream record corresponds to a video stream and the sub-stream records relate to one or more of a Real Time Protocol (RTP) sub-stream of the video stream, a Real Time Control Protocol (RTCP) sub-stream of the video stream and a Real Time Streaming Protocol (RTSP) sub-stream of the video stream.

8. The device of claim 1, wherein the one or more actions includes at least one of: generating one or more alerts; blocking the captured packet and modifying one or more of the stream records.

9. The device of claim 1, wherein the stream model is configured to match the packet information of the captured packet to one of the plurality of stream records by checking the captured packet against its list of streams using end-point addresses that define each particular stream.

10. The device of claim 1, wherein the device is configured to be connected to one of:
the second end-point via a port of a network appliance located between the first and second end-points, the port mirroring network traffic traversing the network appliance; and
an Ethernet tap located between the first and second end-points.

11. The device of claim 1, wherein the device is configured to be located between the first and second end-points such that network traffic between the first and second end-points traverses the device.

12. The device of claim 1, wherein the device is integrated into an IP surveillance network component comprising one of a surveillance device and a network appliance.

13. The device of claim 1, wherein the stream records comprise stream statistics, event ordinality and status of past and currently active stream connections between network end-point pairs.

14. The device of claim 1, wherein the stream model is configured to incorporate data packet information into the stream records based on feedback from the monitor.

15. The device of claim 1, wherein the monitor further comprises an anomaly monitor configured to combine information from the stream manager with the captured packet and to use information and rules from the knowledge base to identify anomalies in at least one of the captured packet and the stream of which it is part, including anomalies specific to IP surveillance networks.

16. The device of claim 15, wherein the anomaly monitor comprises at least one anomaly detector and an alert filter and the device further comprises one or more of an alert manager, a device log, a firewall and a dynamic prevention module, and wherein:
the anomaly detector is configured to: receive the captured packet from the capture filter and stream and packet information from the stream model, apply one or more rules to the captured packet and the stream and packet information, and output information to the alert filter based the application of the one or more rules, and
the alert filter is configured to: evaluate the information received from the anomaly detector, and output alert information based on the evaluation of the information received from the anomaly detector to one or more of the stream manager, alert manager, device log, firewall and dynamic prevention module.

17. The device of claim 1, wherein the knowledge base is adapted to store information including static information about the IP surveillance network, known devices, physical site information and IP surveillance information.

18. The device of claim 17, wherein the information stored by the knowledge base includes policies for IP surveillance networks and devices, a connection matrix defining connections between devices in the network, device types, device properties, vendor specific information, scheduled activities, generic stream structures and behaviour patterns, alarm sources, stream configurations, Open Network Video Interface Forum (ONVIF) profiles, and state information for the network and/or individual network devices.

19. An IP surveillance network comprising a plurality of end-points, the end-points comprising network components including at least one surveillance device and a surveillance management system, the network including one or more network monitoring devices as claimed in any preceding claim deployed to monitor at least one data stream between at least one pair of network end-points.

20. A method of monitoring data streams in an IP surveillance network, the IP surveillance network comprising a plurality of end-points, the end-points comprising network components including at least one surveillance device and a surveillance management system, the method comprising:
capturing, by a capture filter of a surveillance monitor unit, data packets from a data stream between first and second end-points of an IP surveillance network;
for each captured packet:
parsing, by a packet parser of a stream manager of the surveillance monitor unit, the captured packet to obtain packet information of the captured packet;
either:
matching, by a stream model of the stream manager, the packet information of the captured packet to one of a plurality of stream records listed in the stream model, each stream record corresponding to a data stream between a pair of end-points of the IP surveillance network, the stream records listed in the stream model based on one of a plurality of stream templates provided by a knowledge base of the surveillance monitor unit, the knowledge base comprising: information about components of the IP surveillance network; information about data streams between the components of IP surveillance networks; state information regarding the IP surveillance network, network components and network site; a plurality of IP surveillance stream templates for use by the stream model to initialise the stream records; and rules and actions to be applied to captured packets by a monitor module of the surveillance monitor unit, or,
if no match is found, initialising a new stream record for the captured packet based on one of the stream templates provided by the knowledge base;
applying, by the monitor module, one or more rules, provided by the knowledge base and associated with the stream record, to the captured packet based on the packet information of the captured packet and/or the content of the captured packet;
executing by the monitor module one or more actions provided by the knowledge base based on the application of the one or more rules.
